(19) United States
(12) Patent Application Publication
(10) Pub. No.: US 2026/0220073 A1
(43) Pub. Date: Jul. 30, 2026

(54) USB PHY SHARING IN MULTI-PORT SYSTEMS

(71) Applicant: TEXAS INSTRUMENTS INCORPORATED, Dallas, TX (US)

(72) Inventors: Deric Wayne WATERS, Dallas, TX (US); Varun THAKURTA, Noida (IN); Biju ERAYAMKOT PANAYAMTHATTA, Bangalore (IN)

(21) Appl. No.: 19/039,619

(22) Filed: Jan. 28, 2025

(51) Int. Cl. G06F 13/42; G06F 13/38

(52) U.S. Cl. CPC G06F 13/4282; G06F 13/382; G06F 2213/0042

(57) ABSTRACT

In some examples, a method includes determining, via a logic circuit, squelch statuses of each of multiple configuration channels. The method also includes determining, via the logic circuit, a number of missed messages for each of the configuration channels. The method also includes determining, via the logic circuit, a transmit status of a communication policy engine. The method also includes determining, via the logic circuit and based on the squelch status of the configuration channels, the number of missed messages for each of the configuration channels, and the transmit status of a communication policy engine, a configuration channel of the configuration channels to communicatively couple to the communication policy engine. The method also includes communicatively couple the determined configuration channel of the configuration channels to a physical layer circuit.

### BACKGROUND

Universal Serial Bus (USB) is a standard that provides specifications for USB cables and communications protocols for communicating data and/or power between at least two USB capable devices. Multiple specifications exist for various types of USB cables and their attendant capabilities. Some of these types include USB type-A (USB-A), USB type-B (USB-B), USB type-C (USB-C), and others. Communication according to USB specifications or protocols is performed at least in part through a USB physical interface (PHY), such as a USB Power Delivery (USB-PD) PHY or a USB Universal Fast Charging Specification (UFCS) PHY.

### SUMMARY

In some examples, a circuit includes a first set of configuration channel (CC) terminals comprising first and second CC terminals. The circuit also includes a second set of CC terminals comprising third and fourth CC terminals. The circuit also includes a first multiplexer having first and second inputs, a select input, and an output, the first input of the first multiplexer coupled to the first CC terminal, and the second input of the first multiplexer coupled to the second CC terminal. The circuit also includes a second multiplexer having first and second inputs, a select input, and an output, the first input of the second multiplexer coupled to the third CC terminal, and the second input of the second multiplexer coupled to the fourth CC terminal. The circuit also includes a logic circuit having first and second inputs and an output, the first input of the logic circuit coupled to the output of the first multiplexer, and the second input of the logic circuit coupled to the output of the second multiplexer. The circuit also includes a third multiplexer having first and second inputs, a select input, and an output, the first input of the third multiplexer coupled to the output of the first multiplexer, the second input of the third multiplexer coupled to the output of the second multiplexer, and the select input of the third multiplexer coupled to the output of the logic circuit.

In some examples, a system includes a first communication port comprising first and second CC terminals. The system also includes a second communication port comprising third and fourth CC terminals. The system also includes a first multiplexer having first and second inputs, a select input, and an output, the first input of the first multiplexer coupled to the first CC terminal, and the second input of the first multiplexer coupled to the second CC terminal. The system also includes a second multiplexer having first and second inputs, a select input, and an output, the first input of the second multiplexer coupled to the third CC terminal, and the second input of the second multiplexer coupled to the fourth CC terminal. The system also includes a logic circuit having first, second, and third inputs and an output, the first input of the logic circuit coupled to the output of the first multiplexer, and the second input of the logic circuit coupled to the output of the second multiplexer. The system also includes a third multiplexer having first and second inputs, a select input, and an output, the first input of the third multiplexer coupled to the output of the first multiplexer, the second input of the third multiplexer coupled to the output of the second multiplexer, and the select input of the third multiplexer coupled to the output of the logic circuit. The system also includes a communication policy engine. In an example, the communication policy engine a communication physical layer circuit having first and second inputs and an output, the first input of the communication physical layer circuit coupled to the output of the third multiplexer. The communication policy engine also includes a protocol layer and policy engine circuit having first and second inputs and first and second outputs, the first input of the protocol layer and policy engine circuit coupled to the output of the logic circuit, the second input of the protocol layer and policy engine circuit coupled to the output of the communication physical layer circuit, the first output of the protocol layer and policy engine circuit coupled to the second input of the communication physical layer circuit, and the second output of the protocol layer and policy engine circuit coupled to the third input of the logic circuit.

In some examples, a method includes determining, via a logic circuit, squelch statuses of each of multiple configuration channels. The method also includes determining, via the logic circuit, a number of missed messages for each of the configuration channels. The method also includes determining, via the logic circuit, a transmit status of a communication policy engine. The method also includes determining, via the logic circuit and based on the squelch status of the configuration channels, the number of missed messages for each of the configuration channels, and the transmit status of a communication policy engine, a configuration channel of the configuration channels to communicatively couple to the communication policy engine. The method also includes communicatively couple the determined configuration channel of the configuration channels to a physical layer circuit.

### BRIEF DESCRIPTION OF THE DRAWINGS

FIG. 1 is a block diagram of an example system.

FIG. 2 is a block diagram of an example system.

FIG. 3 is a block diagram of an example system.

FIG. 4 is a block diagram of an example channel selection logic circuit.

FIG. 5 is a block diagram of an example logic circuit.

FIG. 6 is a logic diagram of an example state machine.

FIG. 7 is a logic diagram of an example state machine.

FIG. 8 is a logic diagram of an example state machine.

FIG. 9 is a logic diagram of an example state machine.

FIG. 10 is a block diagram of an example system.

FIG. 11 is a block diagram of an example channel selection logic circuit.

FIG. 12 is a block diagram of an example logic circuit.

FIG. 13 is a logic diagram of an example state machine.

FIG. 14 is a logic diagram of an example state machine.

FIG. 15 is a logic diagram of an example state machine.

FIG. 16 is a flowchart of an example method.

FIG. 17 is a block diagram of an example system.

### DETAILED DESCRIPTION

As described above, communication according to USB specifications or protocols is performed at least in part through a communication physical layer circuit, such as a USB PHY, USB-PD PHY, or the like. The USB-PD PHY may be included in a USB-PD controller, or other circuit, chip, or component that manages or controls USB functions of a device. In some system implementations a one-to-one correspondence exists between USB ports of the system and USB PHY circuits. For example, a system having N USB-PD ports may correspondingly have N USB PHY circuits. However, challenges can arise in these systems. For example, space constraints, power constraints, cost constraints, circuit trace routing complexities, or the like may limit the number of USB PHY circuits which may be practically implemented in a particular application environment. While described herein in terms of a USB PHY, in some examples the USB PHY may instead be replaced by a Universal Fast Charging Specification (UFCS) PHY without departing from the functionality described herein.

Examples of this disclosure provide for sharing a single USB PHY circuit among multiple USB ports. In some examples, a system may have a 3:2 relationship between USB ports and USB PHY circuits, a 2:1 relationship between USB ports and USB PHY circuits, or any other suitable N:M relationship between USB ports and USB PHY circuits. However, challenges may exist in such an N:M relationship, such as arbitrating to which USB PHY circuit inbound communication received at a particular USB port is provided, or to which USB port outgoing communication is provided from a USB PHY circuit.

In an example, a logic circuit detects a Squelch status of each USB port of a system, a number of missed messages (e.g., messages that arrived when the USB PHY was allocated to another channel), and whether an outgoing transmission is requested by a USB PHY circuit. Based on this information, the logic circuit selects a USB port of the system to couple to a particular USB PHY circuit. In this way, a subset of the USB ports may be communicatively coupled to USB PHY circuits at a given time. Various implementations of the shared architecture may be possible, such as detecting or not detecting a cable reset of a USB cable coupled to a USB port, detecting or not detecting a hard reset of a USB cable coupled to a USB port, a sink or source architecture in which a USB PHY circuit is locked to a particular USB port until the USB port is deemed incapable of sending/receiving communication or a USB cable is detached from the USB port, etc. Other implementations of the shared architecture could also include a sink or source architecture in which a USB PHY circuit is locked to a particular USB port until the USB port is deemed incapable of sending/receiving communication or a USB cable is detached from the USB port and remaining USB ports not locked to a USB PHY circuit operate with limited functionality, such as with support for USB-C communication but not USB-PD operation.

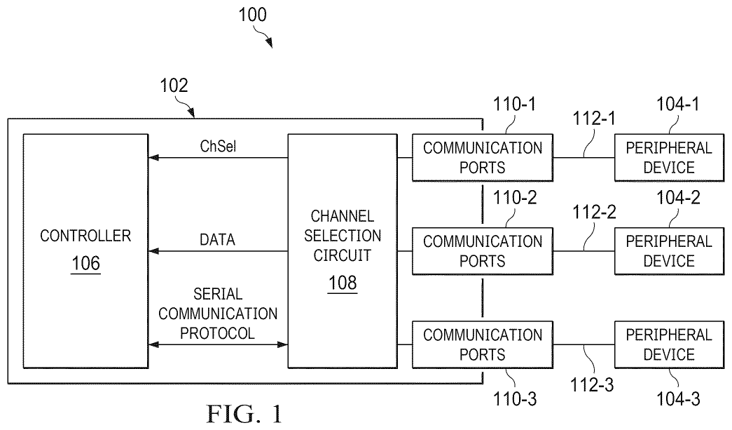

FIG. 1 is a block diagram of an example system 100. In an example, the system 100 is a communication system, such as implementing USB (e.g., implementing USB-PD, UFCS, or the like). In some examples, the system 100 includes a device 102 and peripheral devices 104-1, 104-2, 104-3 (which may be collectively referred to as peripheral devices 104). The device 102 includes a controller 106. In some examples, the controller 106 includes, or may be referred to as, a communication policy engine. In some examples, the controller 106 is a USB controller, such as a USB-PD controller. The controller 106, in at least one example, is a microcontroller having processing capabilities. In other examples, the controller 106 is any processing element capable of receiving one or more inputs and generating one or more outputs based on rules, analysis, or other processing applied to at least some of the inputs. The device 102 also includes a channel selection circuit 108 and communication ports 110-1, 110-2, 110-3 (which may be collectively referred to as the communication ports 110). The channel selection circuit 108, in at least one example, is a microcontroller having processing capabilities. In other examples, the channel selection circuit 108 is any processing element capable of receiving one or more inputs and generating one or more outputs based on rules, analysis, or other processing applied to at least some of the inputs. In some examples, the channel selection circuit 108 includes both logic circuit components (e.g., multiplexers, digital logic gates, etc.) and one or more processing component(s) (e.g., microcontroller, controller, field programmable gate array (FPGA), or the like).

In an example, the peripheral device 104-1 couples through a USB cable 112-1 to the device 102 via the communication port 110-1, the peripheral device 104-2 couples through a USB cable 112-2 to the device 102 via the communication port 110-2, and the peripheral device 104-3 couples through a USB cable 112-3 to the device 102 via the communication port 110-3. The USB cables 112-1, 112-2, 112-3 may collectively be referred to as USB cables 112. The channel selection circuit 108 arbitrates communication between the communication ports 110 and the controller 106. Although shown as separate circuits, in some examples, the controller 106 and the channel selection circuit 108 may be implemented on a same semiconductor die, in a same circuit or component package, or the like. In an example, each communication port 110 includes multiple conductors or terminals. For example, each communication port 110 may be representative of a receptacle to communicatively couple to a plug, such as a USB plug, of a cable. The receptacle may include a bus voltage (VBUS) terminal, a first configuration channel (CC1) terminal, a second configuration channel (CC2) terminal, a connection voltage (VCONN) terminal, and the like, the scope of which is not limited herein. In some examples, such as examples implemented according to UFCS, the receptacle may include positive and negative data terminals (e.g., D+ and D−). At least some of the USB cables 112 include a paddle card (e.g., a circuit board) configured to facilitate communication via the USB cables 112 and one or more electrically conductive or optically transmissive wires to further facilitate communication via the USB cable 112. The paddle card includes one or more electrical components, the scope of which is not limited herein.

Each peripheral device 104 may be any device suitable for coupling to the device 102 to receive power from the device 102, provide power to the device 102, and/or communicate data with the device 102 and the scope of each peripheral device 104, its hardware architecture, or its method of operation are not limited herein. In at least some examples, the peripheral devices 104 also each implement a USB controller substantially similar to the controller 106 and/or includes functionality substantially similar to that described with respect to the device 102.

In an example of operation of the system 100, the channel selection circuit 108 detects a Squelch status of each communication port 110, a number of missed messages received at a respective communication port 110, and/or whether the controller 106 has requested to transmit outbound communication via one of the communication ports 110. As described in greater detail below herein, based on the Squelch status of the communication ports 110, the number of missed messages received at respective communication ports 110, and/or whether the controller 106 has requested to transmit outbound communication via one of the communication ports 110, the channel selection circuit 108 provides a channel selection control signal (ChSel) to the controller 106. In an example, ChSel is a multi-bit signal that indicates to which communication ports 110 (e.g., which channel) the channel selection circuit 108 is communicatively coupling the controller 106. For example, based on ChSel, the channel selection circuit 108 controls whether a content of Data is provided based on communication received at the communication port 110-1, the communication port 110-2, or the communication port 110-3. In some examples, the controller 106 provides control data or other information to the channel selection circuit 108. This control data may be provided according to any suitable bus protocol (e.g., serial communication protocol in the example of FIG. 1).

While various couplings are shown and described herein with respect to the various figures and examples as single couplings between two components, in some examples they be representative of multiple couplings between the two components, such as to provide multiple bits of a multibit value in parallel. For example, a coupling may be implemented via multiple conductors (e.g., wires) to provide multiple bits of data substantially in parallel.

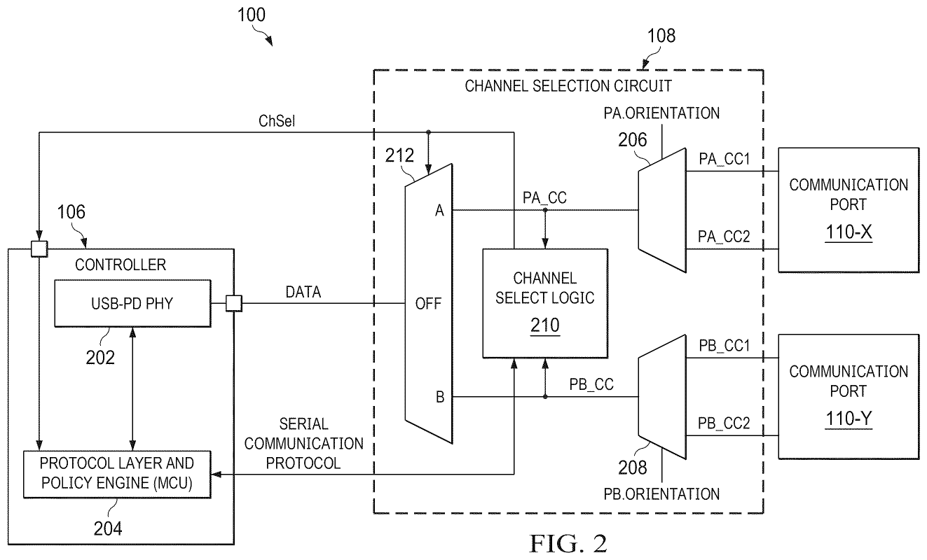

FIG. 2 is a block diagram of the example system 100 in which the channel selection circuit 108 facilitates a 2:1 relationship between communication ports 110 and a USB-PD PHY 202 of the controller 106. The channel selection circuit 108 is coupled to the USB-PD PHY 202. In an example, the controller 106 also includes a protocol layer and policy engine circuit 204, which may be implemented as a microcontroller unit (MCU). The protocol layer and policy engine circuit 204 may be communicatively coupled to the channel selection circuit 108 and the USB-PD PHY 202. In an example, the channel selection circuit 108 includes a multiplexer 206, a multiplexer 208, a channel select logic circuit 210, and a multiplexer 212.

In an example architecture of the system 100 of FIG. 2, the multiplexer 206 has a first input coupled to a first terminal of a first communication port 110-X, where X is selected from the range of [1:3], and a second input coupled to a second terminal of the first communication port 110-X. In some examples, the first terminal is a CC1 terminal and the second terminal is a CC2 terminal. The multiplexer 206 also has a third input (e.g., a select input or a control input) at which a select signal (PA.ORIENTATION) is received, such as from the protocol layer and policy engine circuit 204 via a serial communication protocol, or from any other suitable source or control device. In some examples, the serial communication protocol is Inter-Integrated Circuit (I2C). In other examples, the serial communication protocol is any suitable serial protocol, such as Universal Asynchronous Receiver/Transmitter (UART), Serial Peripheral Interface (SPI), Controller Area Network (CAN), Improved Inter-Integrated Circuit (I3C), or the like. Continuing the example, the multiplexer 208 has a first input coupled to a first terminal of a second communication port 110-Y, where Y is selected from the range of [1:3] and Y≠X, and a second input coupled to a second terminal of the second communication port 110-Y. In some examples, the first terminal is a CC1 terminal and the second terminal is a CC2 terminal. The multiplexer 208 also has a third input (e.g., a select or control input) at which a select signal (PB.ORIENTATION) is received, such as from the protocol layer and policy engine circuit 204 via the serial communication protocol, or from any other suitable source or control device. The channel select logic circuit 210 has a first input coupled to an output of the multiplexer 206, a second input coupled to the output of the multiplexer 208, a third input coupled to an output of the controller 106, and an output coupled to a first input of the controller 106. The multiplexer 212 has a first input coupled to the output of the multiplexer 206, a second input coupled to the output of the multiplexer 208, and an output coupled to a second input of the controller 106. The multiplexer 212 also has a third input (e.g., a select or control input) coupled to the output of the channel select logic circuit 210. In an example, the USB-PD PHY 202 has an input coupled to the second input of the controller 106 and has a bidirectional terminal (e.g., terminal that functions as an input and/or output, or separate dedicated input and output terminals) coupled to a bidirectional terminal of the protocol layer and policy engine circuit 204. The protocol layer and policy engine circuit 204 also has an input coupled to the first input of the controller 106, and has an output coupled to the third input of the channel select logic circuit 210. In an example, the coupling of the protocol layer and policy engine circuit 204 to the channel select logic circuit 210 may facilitate communication via the serial communication protocol, as described above. In some examples, the coupling is bi-directional via a single conductor or associated receive and transmit conductors.

As used herein, the first communication port 110-X may be referred to as Port A, or PA, and the second communication port 110-Y may be referred to as Port B, or PB. For example, PA_CC1 may be a CC1 terminal of Port A, or the communication port 110-X, PB_CC1 may be a CC1 terminal of Port B, or the communication port 110-Y, and the like. However, references to particular ports (e.g., A, B, or C) are not limited to a particular respective communication port 110 and are instead intended to refer to any one of the communication ports 110. For example, in some examples, the first communication port 110-X may be referred to as Port A and the second communication port 110-Y may be referred to as Port B. In other examples, the first communication port 110-X may be referred to as Port B and the second communication port 110-Y may be referred to as Port A. Thus, generally, a Port (e.g., Port A/B/C, PA/PB/PC, signal CC.A/B/C, etc.) may refer to any one of the communication ports 110.

In an example of operation of the system 100 of FIG. 2, based on a value of a first control signal (PA.ORIENTATION) received at the third input of the multiplexer 206, the multiplexer 206 provides either a signal received at the first input of the multiplexer 206 (PA_CC1) as an output signal of the multiplexer 206 (PA_CC) or a signal received at the second input of the multiplexer 206 (PA_CC2) as PA_CC. In some examples, PA.ORIENTATION is indicative of an orientation of USB cable 112-1 with respect to the communication port 110-1. Similarly, based on a value of a second control signal (PB.ORIENTATION) received at the third input of the multiplexer 208, the multiplexer 208 provides either a signal received at the first input of the multiplexer 208 (PB_CC1) as an output signal of the multiplexer 208 (PB_CC) or a signal received at the second input of the multiplexer 208 (PB_CC2) as PB_CC. In some examples, PB.ORIENTATION is indicative of an orientation of USB cable 112-2 with respect to the communication port 110-2. In some examples, PA.ORIENTATION and PB.ORIENTATION may be received from the controller 106, such as communication according to the serial communication protocol. An architecture by which PA.ORIENTATION, PB.ORIENTATION, and PC.ORIENTATION (described below herein) are received is not limited herein. The signals may be received from any suitable source, including at least the controller 106. In one example, the channel selection circuit 108 includes control logic (not shown) that processes serial communication received from the controller 106 and provides the signals based on that received serial communication.

The channel select logic circuit 210 receives PA_CC and PB_CC and, based at least in part on PA_CC and PB_CC determines whether to provide PA_CC or PB_CC from the channel selection circuit 108 to the controller 106 for processing. In some examples, the channel selection circuit 108 also receives data from the controller 106, such as information related to a transmission request by the controller 106. Such data may be provided according to any suitable bus protocol (e.g., serial communication protocol in the example of FIG. 2), the scope of which is not limited herein. In an example, the channel select logic circuit 210 determines whether to provide PA_CC or PB_CC from the channel selection circuit 108 to the controller 106 for processing based on one or more of a Squelch status of the USB ports 110-1, 110-2, a number of missed messages in communication represented in PA_CC, PB_CC, and/or whether an outgoing transmission via one of the USB ports 110-1, 110-2 is requested by the controller 106 (e.g., such as by the protocol layer and policy engine circuit 204). In some examples, the channel select logic circuit 210 makes the determination based on a state machine executed by the channel select logic circuit 210, where a current state of the state machine is determined based on values of one or more input signals and the state machine controls a value of ChSel. Examples of operation of the channel select logic circuit 210 are provided in greater detail below herein. State machines described herein may be implemented according to any suitable architecture or process, the scope of which is not limited herein. For example, state machines may be implemented via logic circuits, a FPGA, a MCU or other processing unit executing firmware (e.g., executing instructions) to implement the state machines, or the like. Some state machines may be implemented according to a first architecture or process and other state machines may be implemented according to a second architecture or process such that not all state machines of this disclosure may not be implemented in the same manner.

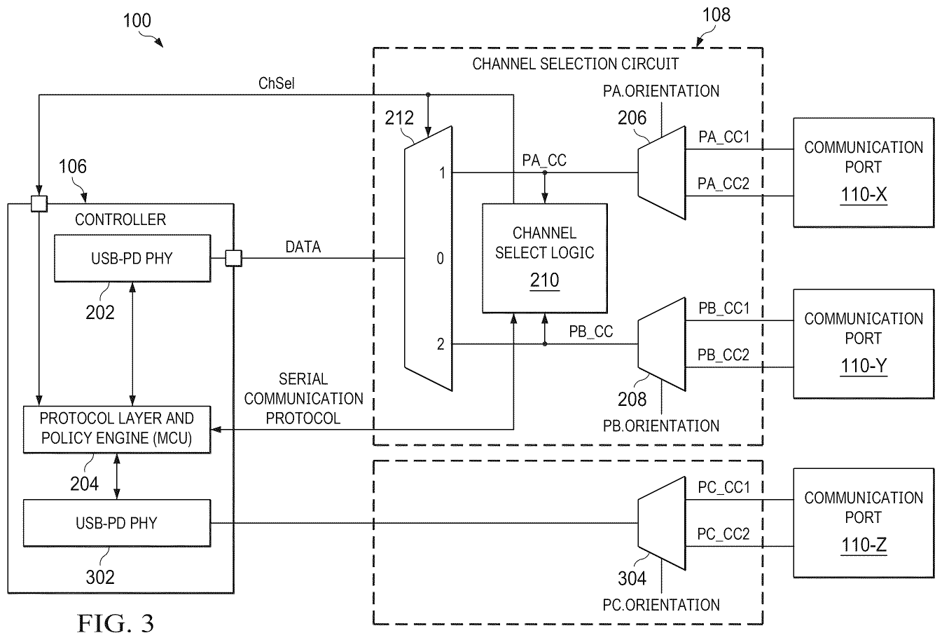

FIG. 3 is a block diagram of the example system 100 which facilitates a 3:2 relationship between communication ports 110 and the USB-PD PHY 202 and a USB-PD PHY 302 of the controller 106. In an example, the system 100 of FIG. 3 includes the USB-PD PHY 202, the protocol layer and policy engine circuit 204, and the channel selection circuit 108 of FIG. 2. The system 100 also includes a multiplexer 304. In some examples, the system 100 may be implemented on multiple dies (e.g., semiconductor dies), in multiple electrical component packages, or the like. For example, the controller 106 may be implemented on a first die, the channel selection circuit 108 may be implemented on a second die, and the multiplexer 304 may be implemented on a third die. Each of the dies may be communicatively coupled together to provide the functionality and architecture described herein. In an example, the multiplexer 304 has a first input coupled to a first terminal of a third communication port 110-Z, where Z is selected from the range of [1:3] with Z≠X and Z≠Y, and a second input coupled to a second terminal of the third communication port 110-Z. In some examples, the first terminal is a CC1 terminal and the second terminal is a CC2 terminal. The multiplexer 304 also has a third input (e.g., a select or control input) at which a select signal (PC.ORIENTATION) is received, such as from the protocol layer and policy engine circuit 204 via the serial communication protocol, or from any other suitable source or control device.

The system 100 of FIG. 3 shows backward compatibility and interoperability of the channel selection circuit 108 with the controller 106 and the multiplexer 304. For example, in some application environments (not shown), a 1:1 relationship may exist between the USB-PD PHY 202 and a communication port, such as via a coupling through a multiplexer similar to the multiplexer 304, and a 1:1 relationship may exist between the USB-PD PHY 302 and another communication port, such as via a coupling through another multiplexer similar to the multiplexer 304. In such an example, the channel selection circuit 108 may not be implemented and the system has a 2:2 relationship between USB-PD PHY circuits and communication ports. However, by replacing one of the multiplexers with the channel selection circuit 108, the system 100 of FIG. 3 may be formed having a 3:2 relationship between the communication ports 110 and the USB-PD PHY 202 and 302. This may be done without modifying a structural architecture of the controller 106.

In various examples, the multiplexer 304, which functions similarly to the multiplexers 206, 208, may be replaced by another instance of the channel selection circuit 108, thereby forming a 4:2 relationship between communication ports and USB-PD PHY circuits. In this way, the system 100 is expandable such that at least some USB-PD PHY circuits of the controller 106 may be associated with more than one communication port, more than two communication ports, or the like.

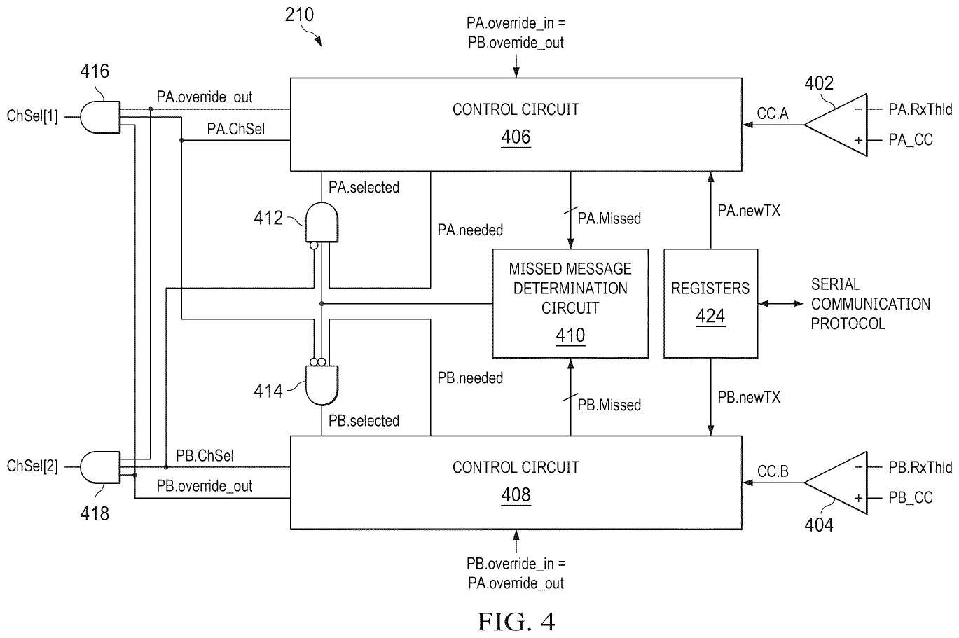

FIG. 4 is a block diagram of an example channel select logic circuit 210. In some examples, the channel select logic circuit 210 is formed via a combination of discrete digital logic circuits (e.g., gates) and processing circuits. In other examples, the channel select logic circuit 210 is formed via a programmable gate array, such as a field programmable gate array (FPGA), which may also implement, or be coupled to, processing circuits. While various couplings of the channel select logic circuit 210 are shown as single couplings between two components, in some examples they be representative of multiple couplings between the two components, such as to provide multiple bits of a multibit value in parallel.

In an example, the channel select logic circuit 210 includes a comparator 402, a comparator 404, a control circuit 406, a control circuit 408, a missed message determination circuit 410, an AND logic circuit 412, an AND logic circuit 414, an AND logic circuit 416, and an AND logic circuit 418. Although illustrated as single components, at least some of the logic circuits 412, 414, 416, 418 may be implemented by a combination of logic circuits to perform the functionality described herein, such as to provide multi-bit functionality. The combination of logic circuits may be of any suitable nature to perform the described functionality, the scope of which is not limited herein. The channel select logic circuit 210 also include registers 424. Further, while shown as components of the channel select logic circuit 210, in some examples the comparator 402 and/or the comparator 404 may be implemented external to the channel select logic circuit 210 and coupled to the channel select logic circuit 210.

In an example architecture of the channel select logic circuit 210, the comparator 402 has a first input coupled to the output of the multiplexer 206 and a second input at which a signal representative of a first threshold value (PA.RxThld) is provided. In some examples, the comparator 402 may be referred to as, or may function as, a squelch detection logic circuit for the first USB port 110-X. The comparator 402 has an output at which a signal CC.A is provided based on a comparison between PA_CC and PA.RxThld. The comparator 404 has a first input coupled to the output of the multiplexer 208 and a second input at which a signal representative of a second threshold value (PB.RxThld) is provided. The threshold values PA.RxThld and PB.RxThld, as well as PC.RxThld (described below herein) may be received from any suitable source, the scope of which is not limited herein. In some examples, the threshold values are received from the controller 106. In other examples, the threshold values are generated within the channel selection circuit 108. In some examples, such generation may be based on one or more control signal received from the controller 106 (e.g., such as indicating whether the system 100 is operating in a sink or source mode). In yet other examples, the threshold values are received from a component not shown. In some examples, the comparator 404 may be referred to as, or may function as, a squelch detection logic circuit for the second USB port 110-Y. The comparator 404 has an output at which a signal CC.B is provided based on a comparison between PB_CC and PB.RxThld. The control circuit 406 has first, second, third, and fourth inputs, and has first, second, third, and fourth outputs. In an example, the first input of the control circuit 406 is coupled to the output of the comparator 402. The control circuit 408 has first, second, third, and fourth inputs, and has first, second, third, and fourth outputs. In an example, the first input of the control circuit 408 is coupled to the output of the comparator 404.

The missed message determination circuit 410 has first and second inputs and has an output. The first input of the missed message determination circuit 410 is coupled to the first output of the control circuit 406 and the second input of the missed message determination circuit 410 is coupled to the first output of the control circuit 408. The AND logic circuit 412 has first, second, and third inputs, and has an output. The first input of the AND logic circuit 412 is coupled to the second output of the control circuit 406, the second input of the AND logic circuit 412 is coupled to the output of the missed message determination circuit 410, and the third input of the AND logic circuit 412 is coupled to the third output of the control circuit 408. In an example, the third input of the AND logic circuit 412 is an inverted input, such as implemented by coupling an inverter circuit (not shown) between the third input of the AND logic circuit 412 and the third output of the control circuit 408. The output of the AND logic circuit 412 is coupled to the second input of the control circuit 406. The AND logic circuit 414 has first, second, and third inputs, and has an output. The first input of the AND logic circuit 414 is coupled to the second output of the control circuit 408, the second input of the AND logic circuit 414 is coupled to the output of the missed message determination circuit 410, and the third input of the AND logic circuit 414 is coupled to the third output of the control circuit 406. In an example, the second and third inputs of the AND logic circuit 414 are each inverted inputs, such as implemented by coupling inverter circuits (not shown) between the second input of the AND logic circuit 414 and the output of the missed message determination circuit 410, and between the third input of the AND logic circuit 414 and the third output of the control circuit 406, respectively. The output of the AND logic circuit 414 is coupled to the second input of the control circuit 408.

The AND logic circuit 416 has first, second, and third inputs and an output. The first input of the AND logic circuit 416 is coupled to the third output of the control circuit 406, the second input of the AND logic circuit 416 is coupled to the fourth output of the control circuit 406, and the third input of the AND logic circuit 416 is coupled to the third output of the control circuit 408. The AND logic circuit 418 has first, second, and third inputs and an output. The first input of the AND logic circuit 418 is coupled to the third output of the control circuit 406, the second input of the AND logic circuit 418 is coupled to the fourth output of the control circuit 408, and the third input of the AND logic circuit 418 is coupled to the fourth output of the control circuit 408. In an example, ChSel may be a multibit value representable in binary form as (ChSel[2] ChSel[1]) b. In some examples, the AND logic circuit 416 provides ChSel[1] at its output and the AND logic circuit 418 provides ChSel[2] at its output. The third input of the control circuit 406 is coupled to the fourth output of the control circuit 408 and the third input of the control circuit 408 is coupled to the fourth output of the control circuit 406. The fourth input of the control circuit 406 and the fourth input of the control circuit 408 are each coupled to the registers 424. In some examples, the registers 424 are I2C registers that store data received from the controller 106.

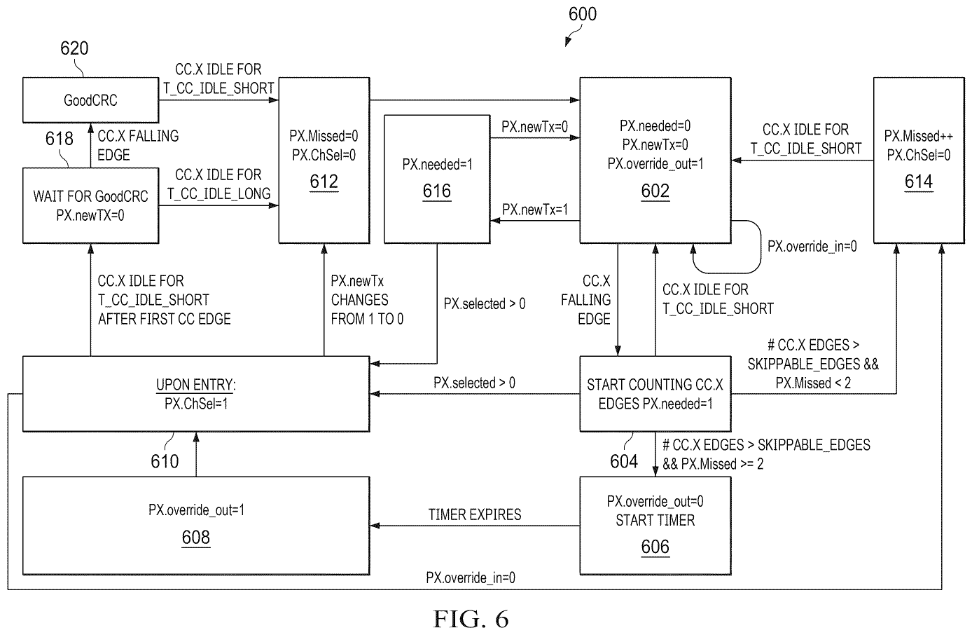

In an example of operation of the channel select logic circuit 210, the comparator 402 determines whether a value of PA_CC has crossed a received signal threshold represented by PA.RxThld. Responsive to PA_CC crossing the threshold PA.RxThld, the comparator 402 provides CC.A having a value representative of PA_CC. Based on CC.A, PA.newTx, PA.selected, and PA.override_in, the control circuit 406 performs processing to determine values for signals PA.Missed, PA.needed, PA.ChSel, and PA.override_out. In an example, the control circuit 406 receives CC.A at its first input from the comparator 402, receives PA.newTX at its second input from the registers 424, receives PA.selected at its third input from the logic circuit 412, and receives PA.override_in at its fourth input from the control circuit 408. The control circuit 406 also provides PA.Missed at its first output to the missed message determination circuit 410, provides PA.needed at its second output to the logic circuit 412, provides PA.override_out at its third output to the logic circuits 416, 418 and control circuit 408, and provides PA.ChSel at its fourth output to the logic circuits 416, 418. In some examples, the control circuit 406 performs the processing by implementing or otherwise executing a state machine. The comparator 404 determines whether a value of PB_CC has crossed a received signal threshold represented by PB.RxThld. Responsive to PB_CC crossing the threshold PB.RxThld, the comparator 404 provides CC.B having a value representative of PB_CC. Based on CC.B, PB.newTx, PB.selected, and PB.override_in, the control circuit 408 performs processing to determine values for signals PB.Missed, PB.needed, PB.ChSel, and PB.override_out. In an example, the control circuit 408 receives CC.B at its first input from the comparator 404, receives PB.newTX at its second input from the registers 424, receives PB.selected at its third input from the logic circuit 414, and receives PB.override_in at its fourth input from the control circuit 406. The control circuit 408 also provides PB.Missed at its first output to the missed message determination circuit 410, provides PB.needed at its second output to the logic circuit 414, provides PB.override_out at its third output to the logic circuits 416, 418 and control circuit 408, and provides PB.ChSel at its fourth output to the logic circuits 416, 418. In an example, the control circuit 408 performs the processing substantially similar to that of the control circuit 406. Operations of the control circuit 406 and/or 408 based on, and to provide, these signals is described in greater detail elsewhere herein, such as with respect to FIGS. 6-8. In an example, based on the foregoing and following description of operation of the channel select logic circuit 210, ChSel is provided according to the following Table 1.

TABLE 1

| PA.over- | PB.over- | | | |
|---|---|---|---|---|
| ride_out | ride_out | PB.ChSel | PA.ChSel | ChSel |
| 0 | X | X | X | 00b (0) |
| X | 0 | X | X | 00b (0) |
| 1 | 1 | 0 | 0 | 00b (0) |
| 1 | 1 | 0 | 1 | 01b (1) |
| 1 | 1 | 1 | 0 | 10b (2) |
| 1 | 1 | 1 | 1 | invalid |

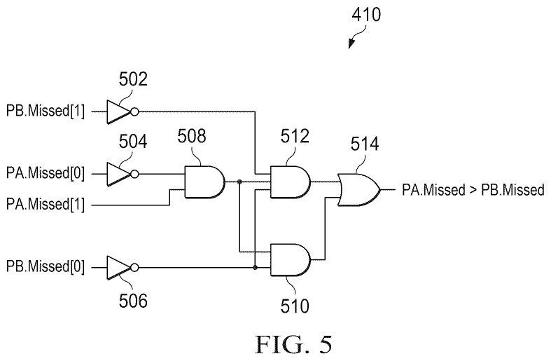

FIG. 5 is a block diagram of an example of the missed message determination circuit 410. In an example, the missed message determination circuit 410 includes an inverter circuit 502, an inverter circuit 504, an inverter circuit 506, an AND logic circuit 508, an AND logic circuit 510, an AND logic circuit 512, and an OR logic circuit 514. In some examples, the missed message determination circuit 410 is formed via a combination of discrete digital logic circuits (e.g., gates). In other examples, the missed message determination circuit 410 is formed via a programmable gate array, such as a FPGA. Although illustrated as single components, at least some of the 502, 504, 506, 508, 510, 512, 514 may be implemented by a combination of circuits (e.g., logic circuits) to perform the functionality described herein.

In an example architecture, the inverter circuit 502, inverter circuit 504, and inverter circuit 506 each have a respective input and output. The AND logic circuit 508 has first and second inputs and an output. The first input of the AND logic circuit 508 is coupled to the output of the inverter circuit 504. The AND logic circuit 510 has first and second inputs and an output. The first input of the AND logic circuit 510 is coupled to the output of the AND logic circuit 508 and the second input of the AND logic circuit 510 is coupled to the output of the inverter circuit 506. The AND logic circuit 512 has first, second, and third inputs and has an output. The first input of the AND logic circuit 512 is coupled to the output of the inverter circuit 502, the second input of the AND logic circuit 512 is coupled to the output of the AND logic circuit 508, and the third input of the AND logic circuit 512 is coupled to the output of the inverter circuit 506. The OR logic circuit 514 has first and second inputs and has an output. The first input of the OR logic circuit 514 is coupled to the output of the AND logic circuit 512 and the second input of the OR logic circuit 514 is coupled to the output of the AND logic circuit 510.

PA.Missed and PB.Missed may each be multi-bit digital values, such as each having 2 bits. In an example of operation of the missed message determination circuit 410, the inverter circuit 502 receives PB.Missed [1] at its input, the inverter circuit 504 receives PA.Missed [0] at its input, the inverter circuit 506 receives PB.Missed [0] at its input, and the AND logic circuit 508 receives PA.Missed [1] at its second input. The circuits 502, 504, 506, 508, 510, 512, 514 are arranged and coupled to perform a logical operation based on PB.Missed, PA.Missed to provide a signal PA.Missed>PB.Missed. The logical operations performed may be defined based on the couplings of the circuits 502, 504, 506, 508, 510, 512, 514 in the missed message determination circuit 410 such that PA.Missed>PB.Missed is determined and provided according to the following logic truth table presented in Table 2.

TABLE 2

| | | | | PA.Missed > |
|---|---|---|---|---|
| PA.Missed[1] | PA.Missed[0] | PB.Missed[1] | PB.Missed[0] | PB.Missed |
| 0 | 0 | 0 | 0 | 0 |
| 0 | 0 | 0 | 1 | 0 |
| 0 | 0 | 1 | 1 | 0 |
| 0 | 0 | 1 | 0 | 0 |
| 0 | 1 | 0 | 0 | 1 |
| 0 | 1 | 0 | 1 | 0 |
| 0 | 1 | 1 | 1 | 0 |
| 0 | 1 | 1 | 0 | 0 |
| 1 | 1 | 0 | 0 | 1 |
| 1 | 1 | 0 | 1 | 1 |
| 1 | 1 | 1 | 1 | 0 |
| 1 | 1 | 1 | 0 | 1 |
| 1 | 0 | 0 | 0 | 1 |
| 1 | 0 | 0 | 1 | 1 |
| 1 | 0 | 1 | 1 | 0 |
| 1 | 0 | 1 | 0 | 0 |

FIG. 6 is a logic diagram of an example state machine 600. The state machine 600 may be implemented or otherwise executed by the control circuit 406 and/or the control circuit 408. Accordingly, description of the state machine 600 may refer to signals shown in FIG. 4, such as receiving or providing the signals. In some examples, the state machine 600 may be implemented by a component capable of performing processing or otherwise determining values for output signals based on values of input signals. The state machine 600 may be defined by a plurality of states. Each state may correspond to a particular set of values for output signals provided by the state machine 600 and the state machine 600 may transition from one state to another state based on receipt of an input signal having a particular value, based on expiration of a period of time, or the occurrence of any other suitable event. As shown in FIG. 6, PX may be replaceable by PA to describe operation with respect to the control circuit 406 and by PB to describe operation with respect to the control circuit 408. As shown in FIG. 6 and referred to elsewhere herein, PX.needed indicates whether that PX_CC should be coupled to the controller 106 (e.g., provided to a USB-PD PHY), PX.override_out indicates whether PX is forcing ChSel to a value of 0, PX.override_in is a corresponding PY.override_out (e.g., PB.override_out PA.override_in and vice versa), and PX.ChSel indicates whether port PX has been selected to provide to the controller 106. PX.PriorityPort is a way to provide a highest priority for PX, PX.Missed is a counter of a number of messages PX has missed since a last received message, and PX.selected indicates that PX has been coupled to the controller 106 (e.g., provided to USB-PD PHY 202) through the multiplexer 212.

At state 602, the state machine 600 provides PX.needed having a value of logical 0 (e.g., PX.needed=0), provides PX.newTx=0, and provides PX.override_out having a value of logical 1 (e.g., PX.override_out=1). In an example, PX.newTX may be a signal received from the controller 106 indicating that the controller 106 seeks to send a message via port PX. Responsive to receiving PX.override_in=0, the state machine 600 remains at state 602. Responsive to receipt of a falling edge in CC.X, the state machine 600 transitions to state 604.

At state 604, the state machine 600 waits to receive communication represented by CC.X. For example, at state 604 the state machine 600 counts a number of falling edges in CC, and provides PX.needed=1. In various examples, the state machine 600 may count the number of falling edges in CC according to any suitable process for implementing a counter, the scope of which is not limited herein. Responsive to the state machine 600 determining that the number of falling edges of CC.X is greater than a number of skippable edges (SKIPPABLE_EDGES) and PX.Missed>=2, the state machine 600 proceeds to state 606. In various examples, SKIPPABLE_EDGES is a programmable value that varies based on a communication protocol in use in the system 100. SKIPPABLE_EDGES represents a number of edges of CC.X that may be missed without compromising an ability of the controller 106 (e.g., a USB-PD PHY) to process a message represented in CC.X. For example, in USB-PD, a preamble of a communication session may have 96 edges reflected in CC.X. As such, SKIPPABLE_EDGES may have any suitable value less than 96. In another example, in UFCS, a preamble of a communication session may have 8 edges reflected in CC.X. As such, SKIPPABLE_EDGES may have any suitable value less than 8.

At state 606, the state machine 600 implements an interrupt timer. In some examples, the interrupt timer provides for a gap in communication between channels (e.g., A and B). The timer may have a value determined based on a communication protocol in use in the system 100. For example, the timer may have a value of approximately 45 microseconds (us) in a USB-PD implementation, about 2 milliseconds (ms) in a UFCS implementation, or any other suitable value. At state 606, the state machine 600 also provides PX.override_out=0. Responsive to expiration of the timer, the state machine 600 proceeds to state 608.

At state 608, the state machine 600 provides PX.override_out=1 and proceeds to state 610.

At state 610, the state machine 600 provides PX.ChSel=1. Responsive to PX.newTx transitioning from having a value of logical 1 to having a value of logical 0 while the state machine 600 is at state 610, the state machine 600 proceeds to state 612.

At state 612, the state machine 600 provides PX.Missed=0 and PX.ChSel=0. Subsequently, the state machine 600 proceeds to state 602.

Returning to state 610, responsive to the state machine 600 receiving PX.override_in=0 while the state machine 600 is at state 610, the state machine 600 proceeds to state 614.

At state 614, the state machine 600 determines that a missed message has occurred. Responsive to the occurrence of the missed message, the state machine 600 increments PX.Missed by one and provides PX.ChSel=0. Responsive to CC.X being idle (e.g., having no detected edges) for T_CC_IDLE_SHORT, the state machine 600 proceeds to state 602. In an example, T_CC_IDLE_SHORT is a duration of time that is longer than a shortest bit width of a communication protocol in use in the system 100. In some examples, the slowest bit width is about 3.7 us and T_CC_IDLE_SHORT is about 10 us.

Returning to state 604, responsive to the state machine 600 determining that the number of edges of CC.X is greater than SKIPPABLE_EDGES and PX.Missed<2, the state machine 600 proceeds to state 614. Continuing at state 604, responsive to CC.X being idle for T_CC_IDLE_SHORT, the state machine 600 proceeds to state 602. Still at state 604, responsive to the state machine 600 determining that PX.selected>0, the state machine 600 proceeds to state 610.

Returning to state 602, responsive to the state machine 600 receiving PX.newTx=1, the state machine 600 proceeds to state 616. At state 616, the state machine 600 provides PX.needed=1 and waits to receive communication from the controller 106. Responsive to the state machine 600 determining that PX.selected>0, the state machine 600 proceeds to state 610. Responsive to the state machine 600 receiving PX.newTx=0, the state machine 600 proceeds to state 602.

Returning to state 610, responsive to CC.X being idle for T_CC_IDLE_SHORT after detection of a first falling edge in CC.X, the state machine 600 proceeds to state 618. At state 618, the state machine 600 waits to communicate a GoodCRC message (e.g., receive responsive to a transmission by the controller 106 or transmit in response to a reception by the controller 106). At state 618, the state machine 600 also provides PX.newTx=0. Responsive to CC.X being idle for T_CC_IDLE_LONG, the state machine 600 proceeds to state 612. In an example, T_CC_IDLE_LONG is a duration of time that is longer than a transmission time specified for a communication protocol in use in the system 100. In some examples, T_CC_IDLE_LONG is about 215 us. Continuing at state 618, responsive to the state machine 600 detecting a falling edge in CC.X, the state machine 600 proceeds to state 620. At state 620, a GoodCRC message is communicated (e.g., transmitted or received). Responsive to CC.X being idle for T_CC_IDLE_SHORT, the state machine 600 proceeds to state 612.

In some examples, the controller 106 may refrain from providing PX.newTx=1 on a port when PX.Missed>0 for any port in the system 100. In this way, an incoming transmission is not overridden by an outgoing transmission. Similarly, controller 106 may refrain from initiating SOP′ traffic on a port when PX.Missed>0 for any port in the system 100 to avoid creating an increased potential for message collisions. This may be particularly relevant for SOP′ message types because the responses to an SOP′ message are not retried. In a USB-PD system, such as the system 100, a sinking device (e.g., a peripheral device 104) may send/receive messages to/from a sourcing device (e.g., the device 102) using USB-PD messages containing a specific 20-bit signature called SOP (start of packet). The device 102 may also send/receive messages to an eMarker in a USB cable coupling the sourcing and sinking devices using USB-PD messages containing a specific 20-bit signature called SOP′. The non-transmitting device (e.g., 102 or 104) knows to ignore the SOP′ message. Likewise, other categories of messages with different 20-bit signatures called SOP″, SOP′ DEBUG, and SOP″ DEBUG may be defined, indicating which entity should process and/or respond to the message. In some examples, the controller 106 may force one port of the system 100 to be given priority over another port of the system 100 by writing a value of 2 to PX.Missed for the port having priority. In some examples, the writing may be via I2C such that the state machine 600 reads the written value from the registers 424.

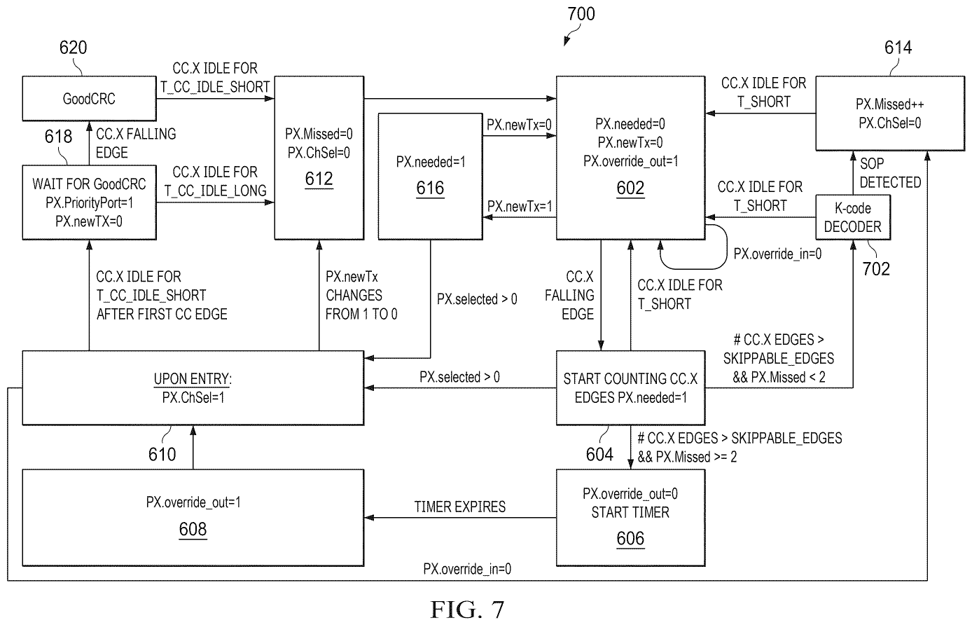

FIG. 7 is a logic diagram of an example state machine 700. The state machine 700 may be implemented or otherwise executed by the control circuit 406 and/or the control circuit 408. Accordingly, description of the state machine 700 may refer to signals shown in FIG. 4, such as receiving or providing the signals. In some examples, the state machine 700 may be implemented by a component capable of performing processing or otherwise determining values for output signals based on values of input signals. The state machine 700 may be defined by a plurality of states. Each state may correspond to a particular set of values for output signals provided by the state machine 700 and the state machine 700 may transition from one state to another state based on receipt of an input signal having a particular value, based on expiration of a period of time, or the occurrence of any other suitable event. As shown in FIG. 7, PX may be replaceable by PA to describe operation with respect to the control circuit 406 and by PB to describe operation with respect to the control circuit 408.

The state machine 700 may be similar to the state machine 600 of FIG. 6, and description of states of the state machine 700 having substantially the same operation as states of the state machine 600 is not repeated herein with respect to FIG. 7. The state machine 700 includes a state 702. At state 604, responsive to the state machine 700 determining that the number of edges of CC.X is greater than SKIPPABLE_EDGES and PX.Missed>=2, the state machine 700 proceeds to state 702. At state 702, the state machine 700 determines a type of message represented in CC.X. For example, a decoder (such as a K-code decoder) decodes that some bits provided in CC.X to determine whether a specific set of bits is present. The specific set of bits may represent a particular message. For example, USB-PD messages have a 20-bit sequence following the preamble called Start-of-Packet (SOP). There may be multiple valid values (e.g., bit sequences) that may be of interest in some systems, but in many applications only one or two of these possible values would be of interest at a given time. Therefore, if the SOP sequence of interest is not contained in the missed message, then the message is not counted as missed (e.g., PX.Missed is not incremented). For example, if CC.X is idle for T_CC_IDLE_SHORT, the state machine 700 transitions from state 702 to state 602 without passing through state 614. However, if the SOP sequence of interest is detected at state 702 the state machine 700 transitions to state 614. In some examples, the state machine 700 may also determine at state 702 whether a hard reset has occurred, such as via another of the possible bit sequences represented in CC.X. Responsive to determining that the hard reset has occurred, the state machine 700 may notify the controller 106 of the hard reset. In some examples, the notification is via I2C or another suitable communication protocol.

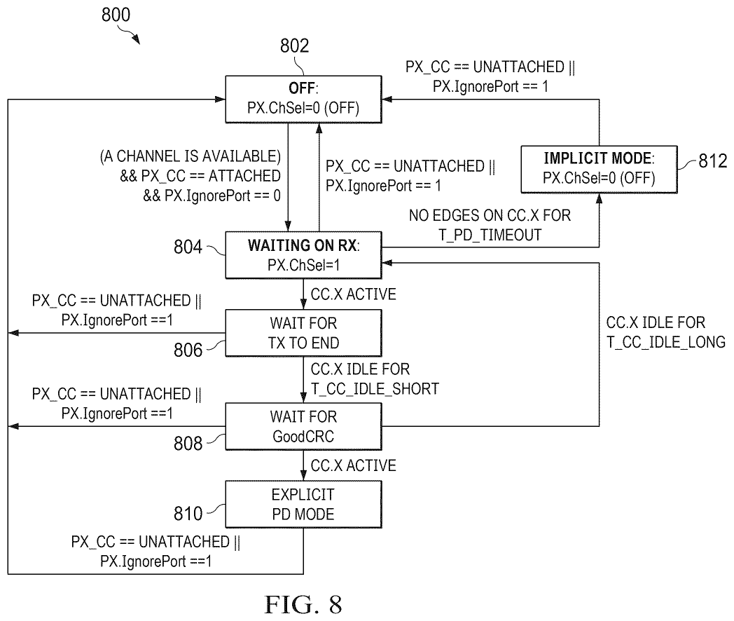

FIG. 8 is a logic diagram of an example state machine 800. In some examples, the state machine 800 may be implemented as the channel select logic circuit 210 in a device functioning as a source in a USB system. Accordingly, description of the state machine 800 may refer to signals shown in FIG. 4, such as receiving or providing the signals. The state machine 800 may be implemented or otherwise executed by a component capable of performing processing or otherwise determining values for output signals based on values of input signals. The state machine 800 may be defined by a plurality of states. Each state may correspond to a particular set of values for output signals provided by the state machine 800 and the state machine 800 may transition from one state to another state based on receipt of an input signal having a particular value, based on expiration of a period of time, or the occurrence of any other suitable event. In an example, the state machine 800 may facilitate USB-PD operability on only one port at a time, with a remainder of ports of the system operating with reduced capabilities. A port receiving USB-PD capability may be determined, in some examples, on a first-come, first-served basis. In some examples, remaining ports may receive reduced capabilities, such as USB-C only capabilities.

At state 802, the channel select logic circuit 210 may be off such that PX.ChSel=0 (e.g., PX is not communicatively coupled to provide PX_CC to a USB-PD PHY). In some examples, at state 802 the system may be in an unattached mode. For example, a communication cable (e.g., USB cable 112) may not be coupled to a port (e.g., communication port 110) of the system 100 or a voltage at PX may have an insufficient value. In an example, the state machine 800 may determine that the communication cable is unattached responsive to PX_CC1 and PX_CC2 both having values greater than an upper threshold value constantly for a minimum time T_DEB1 (such as about 40 us). The communication cable and/or peripheral device 104 being unattached may be referred to as PX_CC==UNATTACHED). Responsive to a channel being available (e.g., one of the USB-PD PHY instantiations is not currently communicatively coupled to a port) a communication cable being attached to a port (e.g., PortX), and PX.IgnorePort=0, the state machine 800 proceeds to state 804. In some examples, PX.IgnorePort is a signal received from the controller 106, such as from the protocol layer and policy engine circuit 204, that prevents PX from asserting PX.ChSel=1. In an example, the state machine 800 may determine that the communication cable and peripheral device 104 are attached responsive to PX_CC1 and/or PX_CC2 having a value in between a lower threshold value and an upper threshold value constantly for a minimum time T_DEB2 (such as about 100 ms). The communication cable and/or peripheral device 104 being attached may be referred to as PX_CC==ATTACHED.

At state 804, the state machine 800 waits for received communication and provides PX.ChSel=1. The state machine 800 determines whether the communication cable remains attached to the port. Responsive to the communication cable being unattached from the port or PX.IgnorePort=1, the state machine 800 transitions to state 802. Responsive to the communication cable remaining attached to the port and detection of a certain number (such as 3) of edges (e.g., rising or falling) within a certain time (such as 20 us) in CC.X, the state machine 800 determines that PX_CC is active and transitions to state 806.

At state 806, the state machine 800 waits for an end of a current transmission represented in CC.X. The state machine 800 also determines whether the communication cable remains attached to the port. Responsive to the communication cable being unattached from the port or PX.IgnorePort=1, the state machine 800 transitions to state 802. Responsive to CC.X being idle (e.g., having no detected edges) for T_CC_IDLE_SHORT, the state machine 800 proceeds to state 808.

At state 808, the state machine 800 waits for a GoodCRC, such as described above herein with respect to state 618 of the state machine 600 of FIG. 6. The state machine 800 also determines whether the communication cable and peripheral device 104 remain attached to the port. Responsive to the peripheral device 104 being unattached from the port or PX.IgnorePort=1, the state machine 800 transitions to state 802. Responsive to detection of CC.X being active, the state machine 800 transitions to state 810.

At state 810, the system enters an explicit PD mode. In the explicit PD mode, the peripheral device 104 and the controller 106 may be exchanging USB-PD messages. The state machine 800 also determines whether the peripheral device 104 remains attached to the port. Responsive to the peripheral device 104 being unattached from the port or PX.IgnorePort=1, the state machine 800 transitions to state 802. Otherwise, the state machine 800 remains at state 810.

Returning to state 804, responsive to the state machine 800 detecting no edges in CC.X for a period of time T_PD_TIMEOUT (such as about 600 ms), the state machine transitions to state 812. At state 812, the system operates in an implicit mode of operation (e.g., such as operates according to USB-C). In the implicit mode, the peripheral device 104 and the controller 106 are not exchanging USB-PD messages, and therefore functionality may be limited. The state machine 800 also provides PX.ChSel=0. The state machine 800 further determines whether the peripheral device 104 remains attached to the port. Responsive to the peripheral device 104 being unattached from the port or PX.IgnorePort=1, the state machine 800 transitions to state 802.

Returning to state 808, responsive to CC.X being idle (e.g., having no detected edges) for T_CC_IDLE_LONG, the state machine 800 transitions to state 804.

In some examples, the state machine 800 may be instantiated for each port (e.g., PX, PY, PZ, etc.) in a system. The transition from state 802 to state 804 that checks to see whether a channel is available (e.g., no port currently has PX.ChSel=1 in a N:1 system or less than M ports has PX.ChSel=1 in a N:M system) provides that only M ports of the system receives USB-PD capabilities at a given time. For example, in a system with a 2:1 relationship between ports and USB-PD PHY circuits, a channel available from the perspective of PX indicates that PY.ChSel=0, and vice versa. Similarly, in a system with a 3:2 relationship between ports and USB-PD PHY circuits, a channel available from the perspective of PX indicates that PY.ChSel=0 or PZ.ChSel=0, and vice versa for each of PY and PZ.

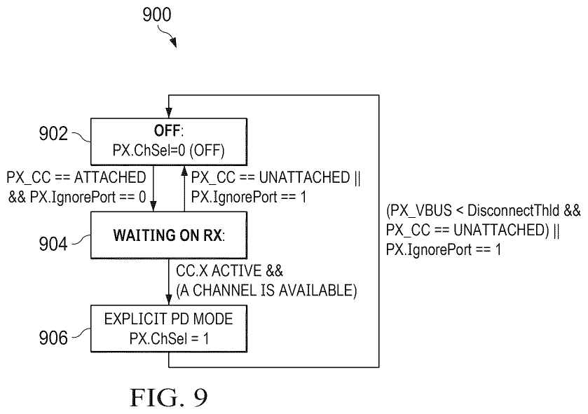

FIG. 9 is a logic diagram of an example state machine 900. In some examples, the state machine 900 may be implemented as the channel select logic circuit 210 in a device functioning as a sink in a USB system. Accordingly, description of the state machine 900 may refer to signals shown in FIG. 4, such as receiving or providing the signals. The state machine 900 may be implemented or otherwise executed by a component capable of performing processing or otherwise determining values for output signals based on values of input signals. The state machine 900 may be defined by a plurality of states. Each state may correspond to a particular set of values for output signals provided by the state machine 900 and the state machine 900 may transition from one state to another state based on receipt of an input signal having a particular value, based on expiration of a period of time, or the occurrence of any other suitable event. In an example, the state machine 900 may facilitate USB-PD operability on only one port at a time, with a remainder of ports of the system operating with reduced capabilities. A port receiving USB-PD capability may be determined, in some examples, on a first-come, first-served basis. In some examples, remaining ports may receive reduced capabilities, such as USB-C only capabilities.

At state 902, the channel select logic circuit 210 may be off such that PX.ChSel=0 (e.g., PX is not communicatively coupled to provide PX_CC to a USB-PD PHY). In some examples, at state 902 the system may be in an unattached mode, such as described above with respect to state 802 of the state machine 800 of FIG. 8. Responsive to a peripheral device 104 being attached to a port (e.g., PortX) and PX.IgnorePort=0, the state machine 900 proceeds to state 904. In some examples, PX.IgnorePort is a signal received from the controller 106, such as from the protocol layer and policy engine circuit 204, that prevents PX from asserting PX.ChSel=1. In an example, the state machine 900 may determine that the peripheral device 104 is attached responsive to at least one of PX_CC1 and PX_CC2 having a value greater than an upper threshold value such as about 0.66 V.

At state 904, the state machine 900 waits for received communication. Responsive to the peripheral device 104 being unattached from the port or PX.IgnorePort=1, the state machine 900 transitions to state 902. In an example, the state machine 900 may determine that the peripheral device 104 is attached responsive to PX_CC1 and PX_CC2 both having values less than a lower threshold value such as about 0.2 V. Responsive to detection of CC.X being active (e.g., N edges in CC.X within a period of time T_EDGES) and a channel being available, the state machine 900 transitions to state 906.

At state 906, the system enters an explicit PD mode and the state machine 900 provides PX.ChSel=1. Responsive to a bus voltage of PX (PX_VBUS) having a value less than a disconnection threshold (DisconnectThld) and the peripheral device 104 being unattached from the port, or responsive to PX.IgnorePort=1, the state machine 900 transitions to state 902. Otherwise the state machine 900 remains at state 906.

In some examples, the state machine 900 may be instantiated for each port (e.g., PX, PY, PZ, etc.) in a system. The transition from state 802 to state 804 that checks to see whether a channel is available (e.g., such as described above with respect to the state machine 800 of FIG. 8) provides that only one port of the system receives USB-PD capabilities at a given time. For example, in a system with a 2:1 relationship between ports and USB-PD PHY circuits, a channel available from the perspective of PX indicates that PY.ChSel=0, and vice versa. Similarly, in a system with a 3:2 relationship between ports and USB-PD PHY circuits, a channel available from the perspective of PX indicates that PY.ChSel=0 or PZ.ChSel=0, and vice versa for each of PY and PZ.

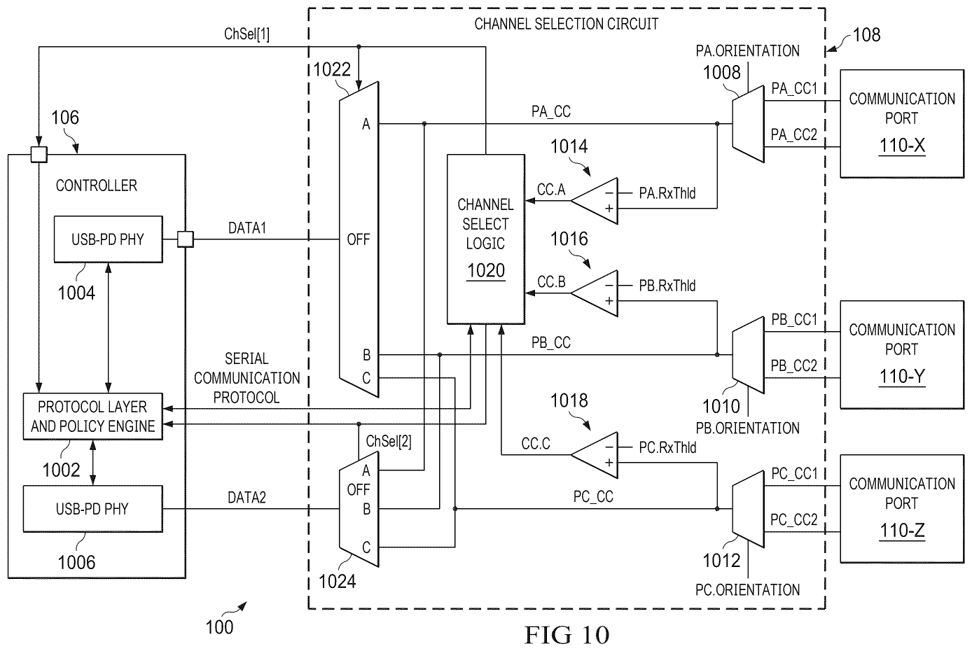

FIG. 10 is a block diagram of the example system 100 in which the channel selection circuit 108 facilitates a 3:2 relationship between communication ports 110 and a USB-PD PHY 1004 or 1006 of the controller 106. In an example, the controller 106 also includes a protocol layer and policy engine 1002, which may be implemented as an MCU. The protocol layer and policy engine 1002 may be communicatively coupled to the channel selection circuit 108 and the USB-PD PHY 1004, 1006. In an example, the channel selection circuit 108 includes a multiplexer 1008, a multiplexer 1010, a multiplexer 1012, a comparator 1014, a comparator 1016, a comparator 1018, channel select logic circuit 1020, a multiplexer 1022, and a multiplexer 1024. In some examples, each of the comparators 1014, 1016, 1018 are implemented as squelch detection logic circuits, such as described above herein with respect to FIG. 4. In some examples, at least some of the comparators 1014, 1016, 1018 are implemented in the channel select logic circuit 1020.

In an example architecture of the system 100 of FIG. 10, the multiplexer 1008 has a first input coupled to a first terminal of a first communication port 110-X, where X is selected from the range of [1:3], and a second input coupled to a second terminal of the first communication port 110-X. In some examples, the first terminal is a CC1 terminal and the second terminal is a CC2 terminal. The multiplexer 1008 also has a third input (e.g., a select or control input) at which a select signal (PC.ORIENTATION) is received, such as from the protocol layer and policy engine circuit 204 via the serial communication protocol, or from any other suitable source or control device. Continuing the example, the multiplexer 1010 has a first input coupled to a first terminal of a second communication port 110-Y, where Y is selected from the range of [1:3] and Y #X, and a second input coupled to a second terminal of the second communication port 110-Y. In some examples, the first terminal is a CC1 terminal and the second terminal is a CC2 terminal. The multiplexer 1010 also has a third input (e.g., a select or control input) coupled to the channel select logic circuit 210. Continuing the example, the multiplexer 1012 has a first input coupled to a first terminal of a third communication port 110-Z, where Z is selected from the range of [1:3] with Z #X and Z #Y, and a second input coupled to a second terminal of the third communication port 110-Z. In some examples, the first terminal is a CC1 terminal and the second terminal is a CC2 terminal. The multiplexer 1012 also has a third input (e.g., a select or control input) coupled to the channel select logic circuit 210. As used herein, the first communication port 110-X may be referred to as Port A, or PA, the second communication port 110-Y may be referred to as Port B, or PB, and the third communication port 110-Z may be referred to as Port C, or PC. For example, PA_CC1 may be a CC1 terminal of Port A, or the communication port 110-X, PB_CC1 may be a CC1 terminal of Port B, or the communication port 110-Y, PC_CC1 may be a CC1 terminal of Port C, or the communication port 110-Z and the like. Each of the comparators 1014, 1016, 1018, in some examples, are comparators having first and second inputs and an output.

The channel select logic circuit 1020 has a first input coupled to an output of the comparator 1014, a second input coupled to the output of the comparator 1016, a third input coupled to the output of the comparator 1018, a fourth input coupled to an output of the controller 106, a first output coupled to a first input of the controller 106, and a second output coupled to a second input of the controller 106. The multiplexer 1022 has a first input coupled to the output of the multiplexer 1008, a second input coupled to the output of the multiplexer 1010, a third input coupled to the output of the multiplexer 1012, and an output coupled to a third input of the controller 106. The multiplexer 1022 also has a fourth input (e.g., a select or control input) coupled to the first output of the channel select logic circuit 210. The multiplexer 1024 has a first input coupled to the output of the multiplexer 1008, a second input coupled to the output of the multiplexer 1010, a third input coupled to the output of the multiplexer 1012, and an output coupled to a fourth input of the controller 106. The multiplexer 1024 also has a third input (e.g., a select or control input) coupled to the second output of the channel select logic circuit 210.

In an example, the USB-PD PHY 1004 has an input coupled to the third input of the controller 106 and has a bidirectional terminal coupled to a first bidirectional terminal of the protocol layer and policy engine 1002. The USB-PD PHY 1006 has an input coupled to the fourth input of the controller 106 and has a bidirectional terminal coupled to a second bidirectional terminal of the protocol layer and policy engine 1002. The protocol layer and policy engine 1002 also has a first input coupled to the first input of the controller 106, a second input coupled to the second input of the controller 106, and has an output coupled to the fourth input of the channel select logic circuit 210.

In an example of operation of the system 100 of FIG. 10, based on a value of a first control signal (PA.ORIENTATION) received at the third input of the multiplexer 1008, the multiplexer 206 provides either a signal received at the first input of the multiplexer 1008 (PA_CC1) as an output signal of the multiplexer 1008 (PA_CC) or a signal received at the second input of the multiplexer 1008 (PA_CC2) as PA_CC. In some examples, PA.ORIENTATION is indicative of an orientation of USB cable 112-1 with respect to the communication port 110-1. Similarly, based on a value of a second control signal (PB.ORIENTATION) received at the third input of the multiplexer 1010, the multiplexer 1010 provides either a signal received at the first input of the multiplexer 1010 (PB_CC1) as an output signal of the multiplexer 1010 (PB_CC) or a signal received at the second input of the multiplexer 1010 (PB_CC2) as PB_CC. In some examples, PB.ORIENTATION is indicative of an orientation of USB cable 112-2 with respect to the communication port 110-2. Still further, based on a value of a third control signal (PC.ORIENTATION) received at the third input of the multiplexer 1012, the multiplexer 1012 provides either a signal received at the first input of the multiplexer 1012 (PC_CC1) as an output signal of the multiplexer 1012 (PC_CC) or a signal received at the second input of the multiplexer 1012 (PC_CC2) as PC_CC. In some examples, PC.ORIENTATION is indicative of an orientation of USB cable 112-3 with respect to the communication port 110-3.

The comparator 1014 receives PA_CC at its first input and a threshold value PA.RxThld at its second input. The comparator 1016 receives PB_CC at its first input and a threshold value PB.RxThld at its second input. The comparator 1018 receives PC_CC at its first input and a threshold value PC.RxThld at its second input. Each of the comparators 1014, 1016, 1018 compares its received CC.X signal to its respective threshold value (e.g., PX.RxThld) to determine whether a value of the signal CC.X is greater than PX.RxThld. Each of the comparators 1014, 1016, 1018 provides an output signal CC.X (e.g., CC.A, CC.B, CC.C) having a value representative of that comparison.

The channel select logic circuit 1020 receives CC.A, CC.B, CC.C and, based at least in part on CC.A, CC.B, CC.C determines which of PA_CC, PB_CC, or PC_CC to provide from the channel selection circuit 108 to the controller 106 for processing. In some examples, the channel select logic circuit 1020 also receives data from the controller 106, such as information related to a transmission request by the controller 106. Such data may be provided according to any suitable bus protocol (e.g., serial communication protocol in the example of FIG. 10), the scope of which is not limited herein. In an example, the channel select logic circuit 1020 determines whether to provide PA_CC, PB_CC, or PC_CC from the channel selection circuit 108 to the controller 106 for processing based on one or more of a Squelch status of the USB ports 110-1, 110-2, 110-3, a number of missed messages in communication represented in PA_CC, PB_CC, PC_CC and/or whether an outgoing transmission via one of the USB ports 110-1, 110-2, 110-3 is requested by the controller 106 (e.g., such as by the protocol layer and policy engine 1002). In some examples, the channel select logic circuit 1020 makes the determination based on a state machine (or multiple state machines) executed by the channel select logic circuit 1020, where a current state of the state machine(s) is determined based on values of one or more input signals and the state machine controls a value of ChSel. In some examples, the channel select logic circuit 1020 implements operates according to, or otherwise implements, the state machine 800 or 900, as described above. Other examples of operation of the channel select logic circuit 1020 are provided in greater detail below herein.

In an example, the USB-PD PHY 1004 may receive one of PA_CC, PB_CC, or PC_CC. The USB-PD PHY 1006 may receive another one of PA_CC, PB_CC, or PC_CC. The respective USB-PD PHY translates analog voltages present in the respective received signal PX_CC into a series of logical high and low (e.g., 1 and 0) values and provides these values to the protocol layer and policy engine 1002. The protocol layer and policy engine 1002 interprets the logical values received from the respective USB-PD PHY to determine a meaning of the received data.

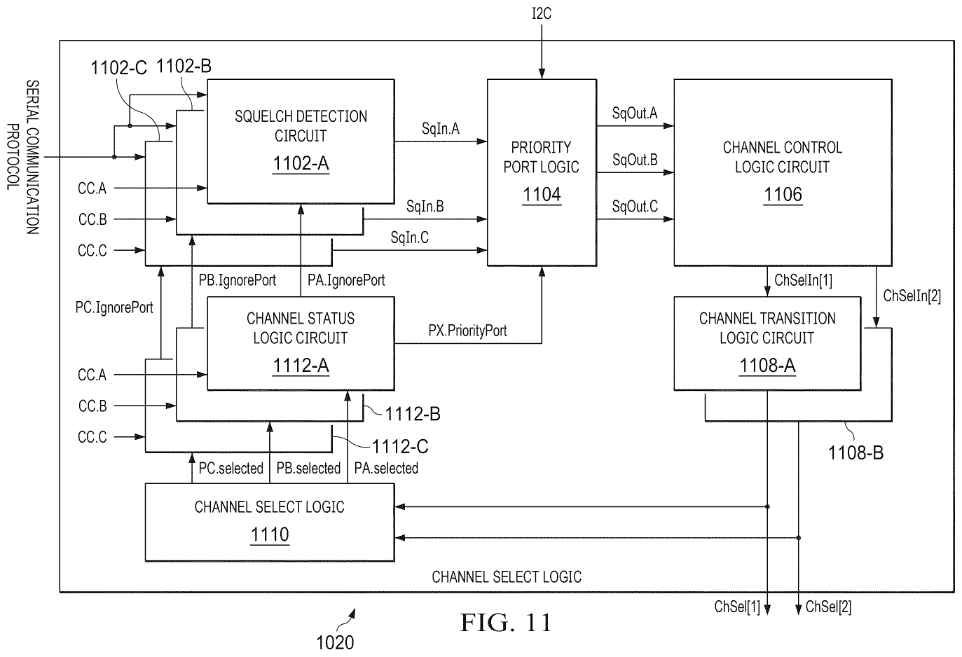

FIG. 11 is a block diagram of an example channel select logic circuit 1020. Accordingly, description of the channel select logic circuit 1020 may refer to signals shown in FIG. 10. In some examples, the channel select logic circuit 1020 is formed via a combination of discrete digital logic circuits (e.g., gates) and processing circuits. In other examples, the channel select logic circuit 1020 is formed via a programmable gate array, such a FPGA, which may also implement, or be coupled to, processing circuits. While various couplings of the channel select logic circuit 1020 are show as single couplings between two components, in some examples they be representative of multiple couplings between the two components, such as to provide multiple bits of a multibit value in parallel.

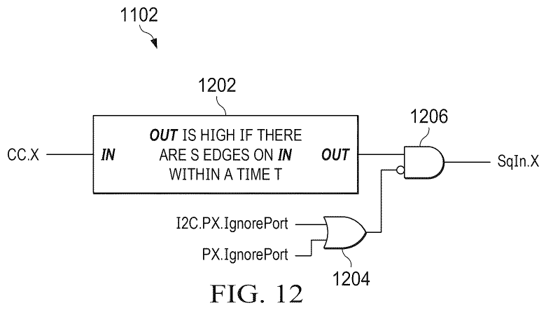

In an example, the channel select logic circuit 1020 implements squelch detection circuits for each of PA, PB, and PC. As such, a first squelch detection circuit 1102-A receives CC.A and provides an output signal SqIn.A, a second squelch detection circuit 1102-B receives CC.B and provides an output signal SqIn.B, and a third squelch detection circuit 1102-C receives CC.C and provides an output signal SqIn.C. The squelch detection circuits 1102-A, 1102-B, 1102-C may function in substantially the same manner and may be referred to herein collectively as the squelch detection circuit 1102. The squelch detection circuit 1102 is described in further detail below with respect to FIG. 12.

The priority port logic circuit 1104 receives SqIn.A, SqIn.B, and SqIn.C, as well as a signal PX.PriorityPort, and based on logical processing, provides SqOut.A, SqOut.B, and SqOut.C. In an example, PX.PriorityPort indicates whether a particular port (e.g., PX) should be given priority over other ports (e.g., PY, PZ, etc.). In some examples, the priority port logic circuit 1104 performs the logical processing via a combination of discrete digital logic circuits (e.g., gates). In other examples, the priority port logic circuit 1104 implements a programmable gate array, such a FPGA, to perform the processing. In an example, SqOut.X indicates whether a particular channel X needs to be coupled to the USB-PD PHY because there is an incoming message. To determine SqOut.A, the priority port logic circuit 1104 implements logical processing according to: SqOut.A=(SqIn.A & ~SqIn.B)|(SqIn.A & ~SqIn.C)|(SqIn.A & ~PriorityPort.C)|(SqIn.A & PriorityPort.A). To determine SqOut.B, the priority port logic circuit 1104 implements logical processing according to: SqOut.B=(~SqIn.A & SqIn.B)|(SqIn.B & ~SqIn.C)|(SqIn.B &~PriorityPort.A)|(SqIn.B & PriorityPort.B). To determine SqOut.B, the priority port logic circuit 1104 implements logical processing according to: SqOut.C=(~SqIn.A & SqIn.C)|(~SqIn.B & SqIn.C)|(SqIn (3) & ~PriorityPort.B)|(SqIn.C & PriorityPort.C). To determine PriorityPort.X, the priority port logic circuit 1104 implements logical processing according to: PriorityPort.X=PX.PriorityPort OR I2C.PX.PriorityPort. In an example, I2C.PX.PriorityPort is a value provided by the controller 106 to directly control assignment of a priority port.

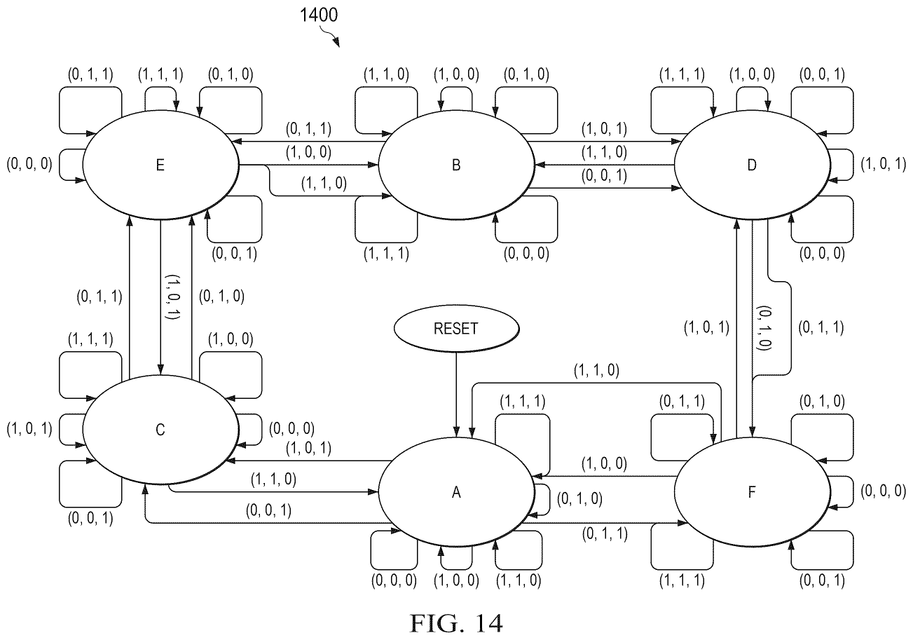

In an example, the channel select logic circuit 1020 further implements a channel control logic circuit 1106, which may implement a state machine or other processing. The channel control logic circuit 1106 receives SqOut.A, SqOut.B, SqOut.C and by performing logical operations based on values of SqOut.A, SqOut.B, SqOut.C, provides ChSelIn [1] and ChSelIn [2]. The channel control logic circuit 1106 is described in further detail below with respect to FIG. 14.

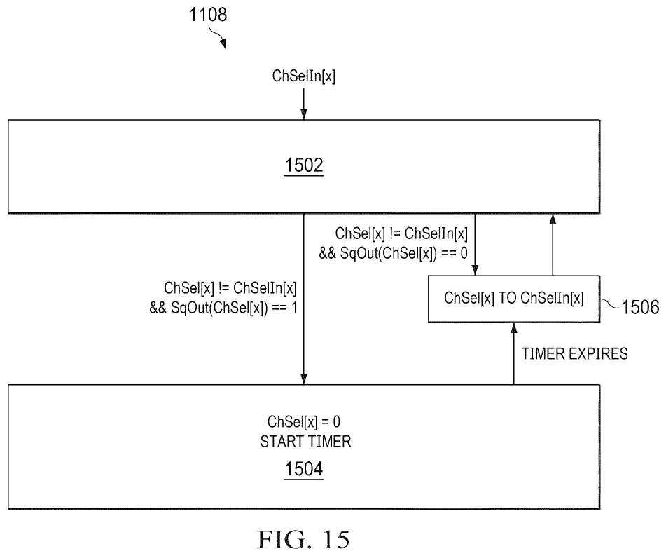

In an example, the channel select logic circuit 1020 further implements channel transition logic circuits 1108-A and 1108-B, which may each implement a state machine or perform other processing. For example, the channel select logic circuit 1020 implements an instance of the channel transition logic circuit 1108 for each channel existing between the channel selection circuit 108 and the controller 106 (e.g., two channels as shown in FIG. 9). The channel transition state machine 1108-A receives ChSelIn [1] and based on various processing, provides ChSel[1]. The channel transition state machine 1108-B receives ChSelIn [2] and based on various processing, ChSel[2]. The channel transition state machines 1108-A and 1108-B are described in further detail below with respect to FIG. 15.

In an example, the channel select logic circuit 1020 further implements channel select logic 1110. The channel select logic 1110 receives ChSel[1] and ChSel[2], and based on logical processing, provides PA.selected, PB.selected, and PC.selected. In some examples, the channel select logic 1110 performs the logical processing via a combination of discrete digital logic circuits (e.g., gates). In other examples, the channel select logic 1110 implements a programmable gate array, such a FPGA, to perform the processing. For example, responsive to ChSel[1]=X or ChSel[2]=X, the channel select logic 1110 provides PX.selected having a value of logic 1. In an example, the channel select logic 1110 includes any suitable analog and/or digital components suitable for determining values for PA.selected, PB.selected, and PC.selected based on received signals ChSel[1] and ChSel[2] according to the following logic truth table presented in Table 3. In an example, ChSel[X] having a value of 00b indicates that the channel is disabled or turned off, a value of 01b indicates that channel A (e.g., Port A or PA) is selected, a value of 10b indicates that channel B (e.g., Port B or PB) is selected, and a value of 11b indicates that channel C (e.g., Port C or PC) is selected.

TABLE 3

| ChSel[1] | ChSel[2] | PA.selected | PB.selected | PC.selected |
|---|---|---|---|---|
| 00b | 00b | 0 | 0 | 0 |
| 00b | 01b | 1 | 0 | 0 |
| 00b | 10b | 0 | 1 | 0 |
| 00b | 11b | 0 | 0 | 1 |
| 01b | 00b | 1 | 0 | 0 |
| 01b | 01b | Not valid | | |
| 01b | 10b | 1 | 1 | 0 |
| 01b | 11b | 1 | 0 | 1 |
| 10b | 00b | 0 | 1 | 0 |
| 10b | 01b | 1 | 1 | 0 |
| 10b | 10b | Not valid | | |
| 10b | 11b | 0 | 1 | 1 |
| 11b | 00b | 0 | 0 | 1 |
| 11b | 01b | 1 | 0 | 1 |
| 11b | 10b | 0 | 1 | 1 |

| | | |
|---|---|---|
| 11b | 11b | Not valid |

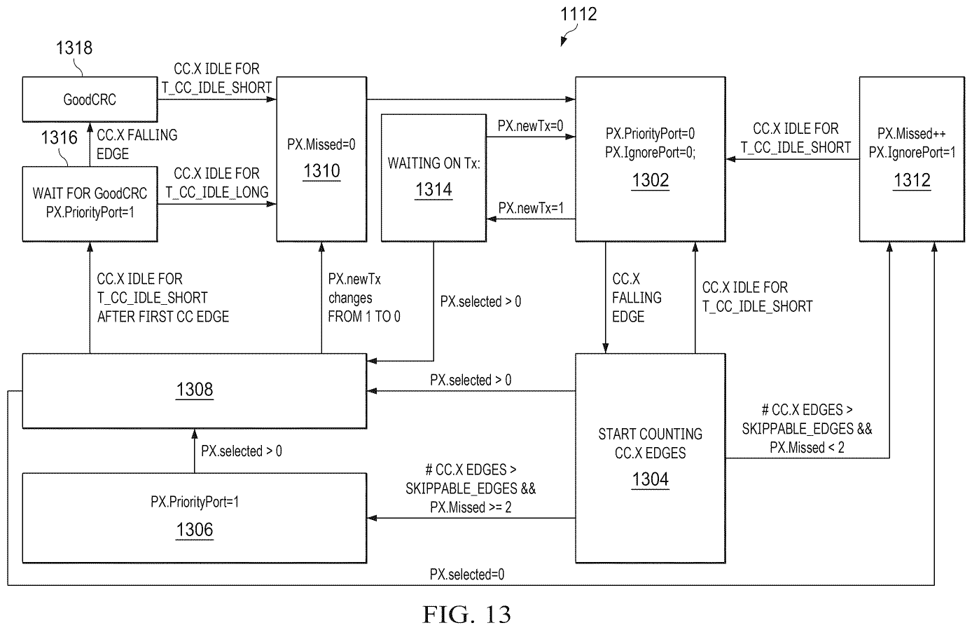

In an example, the channel select logic circuit 1020 further implements channel status logic circuits 1112-A, 1112-B, 1112-C, which may each implement a state machine or perform other processing. For example, the channel select logic circuit 1020 implements an instance of the channel status state machine 1112 for each of PA, PB, and PC. Each instance of the channel status state machine 1112 may be substantially similar to the state machine 600, as described above with respect to FIG. 6, and is described in greater detail below with respect to FIG. 13.

FIG. 12 is a block diagram of an example squelch detection circuit 1102. In an example, the squelch detection circuits 1102 (e.g., each of the circuits 1102-A, 1102-B, 1102-C) includes a circuit 1202, an OR logic circuit 1204, and an AND logic circuit 1206. In an example, the circuit 1202 receives CC.X at an input of the circuit 1202 and, responsive to receipt of S edges (rising or falling) in CC.X, where S is any suitable positive whole number (e.g., S=1, 2, 3, . . . etc.), within a period of time T, provides an output signal (out) having a logical high (e.g., logical 1) value at an output of the circuit 1202. Otherwise, the output signal has a logical low (e.g., logical 0) value. In some examples, T may be in a range of about 10 us to about 20 us. In various examples, the circuit 1202 may have any suitable architecture. In some examples, the circuit 1202 includes a comparator (not shown) implemented as a squelch detector, as described above, to compare CC.X to a threshold value. The circuit 1202 may further include a counter (not shown) that counts edges in an output signal of the comparator. The counter may reset after a certain time T (such as 20 us). Responsive to that count reaching S, the circuit 1202 provides out having the logical high value. In other examples, the circuit 1202 may include an edge detector which, responsive to detection of a rising or falling edge in CC.X, provides out having the logical high value. The OR logic circuit 1204 has first and second inputs and an output. The OR logic circuit 1204 receives a signal I2C.PX.IgnorePort signal from the controller 106 at its first input and PX.IgnorePort from a corresponding channel status state machine 1112 at its second input. In some examples, I2C.PX.IgnorePort and PX.IgnorePort both indicate whether it is permissible to ignore edges on a particular port, such as to reduce priority of that port. The AND logic circuit 1206 has first and second inputs and an output. The AND logic circuit 1206 is coupled at its first input to the output of the circuit 1202 and is coupled at its second input to the output of the OR logic circuit 1204. In an example, the second input of the AND logic circuit 1206 is an inverted input, such as implemented by coupling an inverter circuit (not shown) between the second input of the AND logic circuit 1206 and the output of the OR logic circuit 1204. Based on a logical operation performed by the components of the squelch detection circuit 1102 according to the architecture by which they are coupled, the AND logic circuit 1206 provides SqIn.X at its output.

FIG. 13 is a logic diagram of an example state machine 1300. In an example, the state machine 1300 is suitable for implementation as the channel status state machine 1112-A, the channel status state machine 1112-B, and/or the channel status state machine 1112-C. Accordingly, description of the state machine 1300 may refer to signals shown in FIG. 11, such as receiving or providing the signals. The state machine 1300 may be implemented by a component capable of performing processing or otherwise determining values for output signals based on values of input signals. The state machine 1300 may be defined by a plurality of states. Each state may correspond to a particular set of values for output signals provided by the state machine 1300 and the state machine 1300 may transition from one state to another state based on receipt of an input signal having a particular value, based on expiration of a period of time, or the occurrence of any other suitable event. As shown in FIG. 13, X may be replaceable by A, B, or C to correspond to a particular port PA, PB, or PC.

At state 1302, the state machine 1300 provides PX.PriorityPort=0 and provides PX.IgnorePort=0. Responsive to receipt of a falling edge in CC.X, the state machine 1300 transitions to state 1304.

At state 1304, the state machine 1300 waits to receive communication represented by CC.X. For example, the state machine 1300 counts a number of edges in CC.X. Responsive to the state machine 1300 determining that the number of edges of CC.X is greater than SKIPPABLE_EDGES and PX.Missed>=2, the state machine 1300 proceeds to state 1306.

At state 1306, the state machine 1300 provides PX.PriorityPort=1. Responsive to the state machine 1300 determining that PX.selected>0, the state machine 1300 proceeds to state 1308.

At state 1308, the state machine 1300 is in an ON state. For example, PX (e.g., a determine one of communication port 110-1, 110-2, or 110-3) may be communicatively coupled to a USB-PD PHY (e.g., the USB-PD PHY 1004 or 1006) based on a value of ChSel. Responsive to PX.newTx transitioning from having a value of logical 1 to having a value of logical 0 while the state machine 1300 is at state 1308, the state machine 1300 proceeds to state 1310.

At state 1310, the state machine 1300 sets PX.Missed=0. Subsequently, the state machine 1300 proceeds to state 1302.

Returning to state 1308, responsive to the state machine 1300 receiving PX.selected=0 while the state machine is at state 1308, the state machine 1300 proceeds to state 1312.

At state 1312, the state machine 1300 determines that a missed message has occurred. Responsive to the occurrence of the missed message, the state machine 1300 increments PX.Missed by one and provides PX.IgnorePort=1. Responsive to CC.X being idle for T_CC_IDLE_SHORT, the state machine 1300 proceeds to state 1302.

Returning to state 1304, responsive to the state machine 1300 determining that the number of edges of CC.X is greater than SKIPPABLE_EDGES and PX.Missed<2, the state machine 1300 proceeds to state 1312. Continuing at state 1304, responsive to CC.X being idle for T_CC_IDLE_SHORT, the state machine 1300 proceeds to state 1302. Still at state 1304, responsive to the state machine 1300 determining that PX.selected>0, the state machine 1300 proceeds to state 1308.

Returning to state 1302, responsive to the state machine 1300 receiving PX.newTx=1, the state machine 1300 proceeds to state 1314. At state 1314, the state machine 1300 waits to receive communication from the controller 106. Responsive to the state machine 1300 determining that PX.selected>0, the state machine 1300 proceeds to state 1308. Responsive to the state machine 1300 receiving PX.newTx=0, the state machine 1300 proceeds to state 1302.

Returning to state 1308, responsive to CC.X being idle for T_CC_IDLE_SHORT after detection of a first falling edge in CC.X, the state machine 1300 proceeds to state 1316. At state 1316, the state machine 1300 provides PX.PriorityPort=1 and waits to receive a GoodCRC message. Responsive to CC.X being idle for T_CC_IDLE_LONG, the state machine 1300 proceeds to state 1310. Continuing at state 1316, responsive to the state machine 1300 detecting a falling edge in CC.X, the state machine 1300 proceeds to state 1318. At state 1318, a GoodCRC message is received. Responsive to CC.X being idle for T_CC_IDLE_SHORT, the state machine 1300 proceeds to state 1310.

In some examples, the controller 106 may refrain from providing PX.newTx=1 on a port when PX.Missed>0 for any port in the system 100. In this way, an incoming transmission is not overridden by an outgoing transmission. Similarly, controller 106 may refrain from initiating SOP′ traffic on a port when PX.Missed>0 for any port in the system 100. This may result from SOP′ messages having no retries in response to messages being missed. In an example, the controller 106 determines that it is clear to transmit on a port responsive to ChSel having a value equal to an identifier of the port on which the controller 106 seeks to transmit. In some examples, the controller 106 may force one port of the system 100 to be given priority over another port of the system 100 by writing a value of 2 to PX.Missed for the port having priority.

FIG. 14 is a logic diagram of an example state machine 1400. In an example, the state machine 1400 is suitable for implementation as the channel control logic circuit 1106. Accordingly, description of the state machine 1400 may refer to signals shown in FIG. 11, such as receiving or providing the signals. The state machine 1400 may be implemented by a component capable of performing processing or otherwise determining values for output signals based on values of input signals. The state machine 1400 may be defined by a plurality of states. Each state may correspond to a particular set of values for output signals provided by the state machine 1400 and the state machine 1400 may transition from one state to another state based on receipt of an input signal having a particular value, based on expiration of a period of time, or the occurrence of any other suitable event. As shown in FIG. 14, the state machine 1400 includes a Reset state and states A, B, C, D, E, and F. The state machine 1400 performs logical operations based on received input signals SqOut.A, SqOut.B, and SqOut.C (represented in FIG. 14 as (SqOut.A, SqOut.B, SqOut.C)) to transition among states according to the following logic truth table presented in Table 4 to provide ChSelIn [1] and ChSelIn [2] as presented in the following Table 5.

TABLE 4

| State ID | SqOut.A | SqOut.B | SqOut.C | Next State |
|---|---|---|---|---|
| A | 0 | 0 | 0 | A |
| A | 0 | 0 | 1 | C |
| A | 0 | 1 | 0 | A |
| A | 0 | 1 | 1 | F |
| A | 1 | 0 | 0 | A |
| A | 1 | 0 | 1 | C |
| A | 1 | 1 | 0 | A |
| A | 1 | 1 | 1 | A |
| B | 0 | 0 | 0 | B |
| B | 0 | 0 | 1 | D |
| B | 0 | 1 | 0 | B |
| B | 0 | 1 | 1 | E |
| B | 1 | 0 | 0 | B |
| B | 1 | 0 | 1 | D |
| B | 1 | 1 | 0 | B |
| B | 1 | 1 | 1 | B |
| C | 0 | 0 | 0 | C |
| C | 0 | 0 | 1 | C |
| C | 0 | 1 | 0 | E |
| C | 0 | 1 | 1 | E |
| C | 1 | 0 | 0 | C |
| C | 1 | 0 | 1 | C |
| C | 1 | 1 | 0 | A |
| C | 1 | 1 | 1 | C |
| D | 0 | 0 | 0 | D |
| D | 0 | 0 | 1 | D |
| D | 0 | 1 | 0 | F |
| D | 0 | 1 | 1 | F |
| D | 1 | 0 | 0 | D |
| D | 1 | 0 | 1 | D |
| D | 1 | 1 | 0 | B |
| D | 1 | 1 | 1 | D |
| E | 0 | 0 | 0 | E |
| E | 0 | 0 | 1 | E |
| E | 0 | 1 | 0 | E |
| E | 0 | 1 | 1 | E |
| E | 1 | 0 | 0 | B |
| E | 1 | 0 | 1 | C |
| E | 1 | 1 | 0 | B |
| E | 1 | 1 | 1 | E |
| F | 0 | 0 | 0 | F |
| F | 0 | 0 | 1 | F |
| F | 0 | 1 | 0 | F |
| F | 0 | 1 | 1 | F |
| F | 1 | 0 | 0 | A |
| F | 1 | 0 | 1 | D |
| F | 1 | 1 | 0 | A |
| F | 1 | 1 | 1 | F |

TABLE 5

| State ID | ChSelIn[1] | ChSelIn[2] |
|---|---|---|
| A | PA_CC | PB_CC |
| B | PB_CC | PA_CC |
| C | PA_CC | PC_CC |
| D | PC_CC | PA_CC |
| E | PB_CC | PC_CC |
| F | PC_CC | PB_CC |

FIG. 15 is a logic diagram of an example state machine 1500. In an example, the state machine 1500 is suitable for implementation as the channel transition state machine 1108-A and/or the channel transition state machine 1108-B. Accordingly, description of the state machine 1500 may refer to signals shown in FIG. 11, such as receiving or providing the signals. The state machine 1500 may be implemented by a component capable of performing processing or otherwise determining values for output signals based on values of input signals. The state machine 1500 may be defined by a plurality of states. Each state may correspond to a particular set of values for output signals provided by the state machine 1500 and the state machine 1500 may transition from one state to another state based on receipt of an input signal having a particular value, based on expiration of a period of time, or the occurrence of any other suitable event.

At state 1502, ChSelIn [X] is received. Responsive to ChSel[X] not being equal to ChSelIn [X] and SqOut(ChSel[X])=1, the state machine 1500 transitions to state 1504. As shown in FIG. 15, SqOut(1) is the same as SqOut.A, SqOut(2) is the same as SqOut.B, etc. In some examples, state 1502 may be referred to as a passthrough state in which a value of a signal is not changed as a result of the state machine 1500 operating at state 1502.

At state 1504, the state machine 1500 provides ChSel[X]=0 and begins a timer. In some examples, such as USB-PD implementations, the timer may have a duration of about 25 us. For example, if one channel is getting starved, the channel select logic circuit 1020 may pre-empt another channel in the middle of a message. As a result, the channel select logic circuit 1020, through the state machine 1500, may cause a time gap to occur to cause the controller 106 to see a minimum period of no messages for that time gap before beginning to process new messages. Responsive to the timer expiring, the state machine 1500 proceeds to state 1506.

Returning to state 1502, responsive to ChSel[X] not being equal to ChSelIn [X] and SqOut(ChSel[X])=0, the state machine 1500 transitions to state 1506. At state 1506, the state machine 1500 provides ChSel[X] having a same value as ChSelIn [X]. Subsequently, the state machine 1500 proceeds to state 1502.

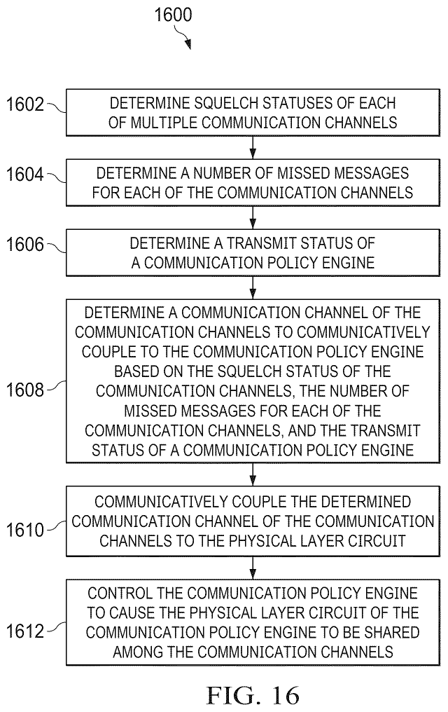

FIG. 16 is a flowchart of an example method 1600. In some examples, the method 1600 is implemented by a channel selection circuit, such as the channel selection circuit 108 of the system 100 of FIG. 1. The method 1600 may be implemented to arbitrate communication between multiple discrete communication ports and a single physical layer circuit or interface. For example, the method 1600 may be implemented to arbitrate communication between multiple USB-PD capable communication ports and a single USB-PD PHY.

At operation 1602, a logic circuit determines squelch statuses of each of multiple configuration channels. In some examples, the squelch status is determined at least in part by comparing a value received via the configuration channels to a threshold value (e.g., PA.RxThld), such as described above herein, such as with respect to FIG. 4 and/or FIG. 10.

At operation 1604, the logic circuit determines a number of missed messages for each of the configuration channels. In some examples, to determine the number of missed messages, the method 1600 comprises determining whether a number of edges in a signal received via the configuration channels within a programmed time period exceeds a threshold, such as described above herein with respect to FIG. 6, FIG. 7, and/or FIG. 13.

At operation 1606, the logic circuit determines a transmit status of a communication policy engine. In some examples, the transmit status is determined based on a signal received from the communication policy engine, such as from a controller that includes the communication policy engine, as described above herein with respect to FIG. 6, FIG. 7, and/or FIG. 13.

At operation 1608, the logic circuit determines a configuration channel of the configuration channels to communicatively couple to the communication policy engine based on the squelch status of the configuration channels, the number of missed messages for each of the configuration channels, and the transmit status of a communication policy engine. In some examples, the determination is based on a result determined by a state machine or other processing, as described above herein with respect to FIG. 6, FIG. 7, and/or FIG. 13. For example, the determination may be a value of ChSel, as described above herein with respect to FIG. 6, FIG. 7, FIG. 13, or any other preceding figure.

At operation 1610, the channel selection circuit communicatively couples the determined configuration channel of the configuration channels to the physical layer circuit. In some examples, the determined configuration channel is communicatively coupled to the physical layer circuit by controlling a multiplexer to provide data from the determined configuration channel to the physical layer circuit based on a channel selection signal determined at operation 1608, such as described above herein with respect to FIG. 2, FIG. 3, and/or FIG. 10.

At operation 1612, the logic circuit controls the communication policy engine to cause the physical layer circuit of the communication policy engine to be shared among the configuration channels. In some examples, the logic circuit controls the communication policy engine to cause the physical layer circuit of the communication policy engine to be shared among the configuration channels by providing the channel selection signal determined at operation 1608 to the communication policy engine, such as described above herein with respect to FIG. 2, FIG. 3, and/or FIG. 10.

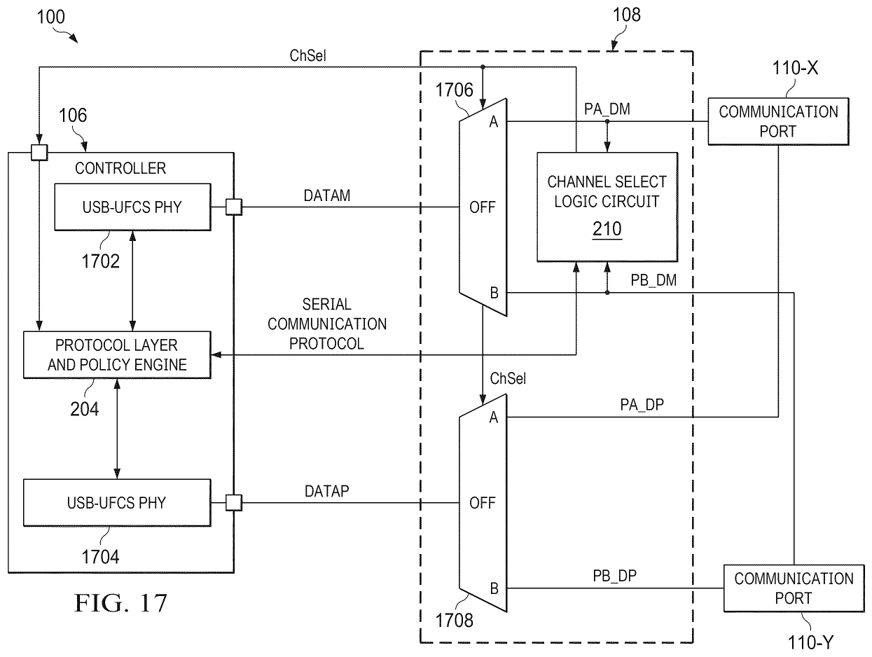

FIG. 17 is a block diagram of the example system 100 which facilitates a N:M relationship between communication ports 110 and USB-UFCS PHY circuits 1702, 1704 of the controller 106 in a USB-UFCS system. In an example, the controller 106 of FIG. 17 includes the protocol layer and policy engine circuit 204, and the channel selection circuit 108 of FIG. 2. The system 100 also includes a multiplexer 1706 and a multiplexer 1708.

In an example, the multiplexer 1706 has a first input coupled to a first terminal of the first communication port 110-X and a second input coupled to a first terminal of the second communication port 110-Y. In some examples, the first terminals of the first communication port 110-X and the second communication port 110-Y are both Data+ terminals. The multiplexer 1706 also has a third input (e.g., a select or control input) coupled to the channel select logic circuit 210. The multiplexer 1708 has a first input coupled to a second terminal of the first communication port 110-X and a second input coupled to a second terminal of the second communication port 110-Y. In some examples, the second terminals of the first communication port 110-X and the second communication port 110-Y are both Data− terminals. The multiplexer 1708 also has a third input (e.g., a select or control input) coupled to the channel select logic circuit 210.

While generally operation in a USB-PD application environment has been described herein, the system 100 of FIG. 17 is representative of operation in a USB-UFCS application environment. Accordingly, reference to CC.X with respect to operation of the channel select logic circuit 210 in the USB-PD application environment may be replaced with PX_DM in the USB-UFCS application environment. Accordingly, in some examples, based on PX_DM (e.g., PA_DM and/or PB_DM), the channel select logic circuit 210 determines, such as according to the operations described above herein with respect to FIG. 4, whether to provide positive component (DATAM) and negative component (DATAP) from the communication port 110-X or 110-Y to the controller 106.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

What is claimed is:

1. A circuit, comprising:
a first set of configuration channel (CC) terminals comprising first and second CC terminals;
a second set of CC terminals comprising third and fourth CC terminals;
a first multiplexer having first and second inputs, a select input, and an output, the first input of the first multiplexer coupled to the first CC terminal, and the second input of the first multiplexer coupled to the second CC terminal;
a second multiplexer having first and second inputs, a select input, and an output, the first input of the second multiplexer coupled to the third CC terminal, and the second input of the second multiplexer coupled to the fourth CC terminal;
a logic circuit having first and second inputs and an output, the first input of the logic circuit coupled to the output of the first multiplexer, and the second input of the logic circuit coupled to the output of the second multiplexer; and
a third multiplexer having first and second inputs, a select input, and an output, the first input of the third multiplexer coupled to the output of the first multiplexer, the second input of the third multiplexer coupled to the output of the second multiplexer, and the select input of the third multiplexer coupled to the output of the logic circuit.

2. The circuit of claim 1, wherein the logic circuit comprises:
registers having first and second outputs;
a first comparator having an output and first and second inputs, the first input of the first comparator coupled to a first terminal, and the second input of the first comparator coupled to the output of the first multiplexer;
a second logic circuit having first, second, third, and fourth inputs, and first, second, third, fourth, and fifth outputs, the first input of the second logic circuit coupled to the output of the first comparator, and the second input of the second logic circuit coupled to the first output of the registers;
a second comparator having an output and first and second inputs, the first input of the second comparator coupled to a second terminal, and the second input of the second comparator coupled to the output of the second multiplexer;
a third logic circuit having first, second, third, and fourth inputs, and first, second, third, fourth, and fifth outputs, the first input of the third logic circuit coupled to the output of the second comparator, the second input of the third logic circuit coupled to the second output of the registers, the third output of the third logic circuit coupled to the fourth input of the second logic circuit, and the third output of the second logic circuit coupled to the fourth input of the third logic circuit;
a fourth logic circuit having first and second inputs and an output, the first input of the fourth logic circuit coupled to the first output of the second logic circuit, and the second input of the fourth logic circuit coupled to the first output of the third logic circuit;
a fifth logic circuit having an output and first, second, and third inputs, the first input of the fifth logic circuit coupled to the second output of the second logic circuit, the second input of the fifth logic circuit coupled to the output of the fourth logic circuit, and the third input of the fifth logic circuit coupled to the fourth output of the third logic circuit;
a sixth logic circuit having an output and first, second, and third inputs, the first input of the sixth logic circuit coupled to the second output of the third logic circuit, the second input of the sixth logic circuit coupled to the output of the fourth logic circuit, and the third input of the sixth logic circuit coupled to the fourth output of the second logic circuit;
a seventh logic circuit having an output and first, second, and third inputs, the first input of the seventh logic circuit coupled to the third output of the second logic circuit, the second input of the seventh logic circuit coupled to the fourth output of the second logic circuit, and the third input of the seventh logic circuit coupled to the third output of the third logic circuit; and
an eighth logic circuit having an output and first, second, and third inputs, the first input of the eighth logic circuit coupled to the third output of the third logic circuit, the second input of the eighth logic circuit coupled to the fourth output of the third logic circuit, and the third input of the eighth logic circuit coupled to the third output of the second logic circuit.

3. The circuit of claim 2, wherein the fourth logic circuit comprises:
a first inverter circuit having an input and an output, the input of the first inverter circuit coupled to the first output of the third logic circuit;
a second inverter circuit having an input and an output, the input of the second inverter circuit coupled to the first output of the second logic circuit;
a third inverter circuit having an input and an output, the input of the third inverter circuit coupled to the first output of the third logic circuit;
a ninth logic circuit having an output and first and second inputs, the first input of the ninth logic circuit coupled to the output of the second inverter circuit, and the second input of the ninth logic circuit coupled to the first output of the second logic circuit;
a tenth logic circuit having an output and first, second, and third inputs, the first input of the tenth logic circuit coupled to the output of the first inverter circuit, the second input of the tenth logic circuit coupled to the output of the ninth logic circuit, and the third input of the tenth logic circuit coupled to the output of the third inverter circuit;
an eleventh logic circuit having an output and first and second inputs, the first input of the eleventh logic circuit coupled to the output of the ninth logic circuit, and the third input of the eleventh logic circuit coupled to the output of the third inverter circuit; and
a twelfth logic circuit having an output and first and second inputs, the first input of the twelfth logic circuit coupled to the output of the tenth logic circuit, the second input of the twelfth logic circuit coupled to the output of the eleventh logic circuit, and the output of the twelfth logic circuit coupled to the second input of the fourth logic circuit and the second input of the fifth logic circuit.

4. The circuit of claim 2, wherein the second logic circuit and the third logic circuit are each configured to execute instructions to implement a state machine.

5. The circuit of claim 1, wherein the logic circuit is configured to provide a control signal at the output of the logic circuit to select one of the first set of CC terminals or the second set of CC terminals for use in communication.

6. The circuit of claim 1, wherein the logic circuit has a third input, the circuit further comprising a communication policy engine comprising:
a communication physical layer circuit having first and second inputs and an output, the first input of the communication physical layer circuit coupled to the output of the third multiplexer; and
a protocol layer and policy engine circuit having first and second inputs and first and second outputs, the first input of the protocol layer and policy engine circuit coupled to the output of the logic circuit, the second input of the protocol layer and policy engine circuit coupled to the output of the communication physical layer circuit, the first output of the protocol layer and policy engine circuit coupled to the second input of the communication physical layer circuit, and the second output of the protocol layer and policy engine circuit coupled to the third input of the logic circuit.

7. The circuit of claim 6, wherein the logic circuit is configured to:
provide a channel selection control signal to the protocol layer and policy engine circuit, the channel selection control signal configured to control the protocol layer and policy engine circuit to use one of the first set of CC terminals or the second set of CC terminals for communication by the communication policy engine; and
determine a value of the channel selection control signal based on a squelch status of the first set of CC terminals and the second set of CC terminals, a number of missed messages at the first set of CC terminals and the second set of CC terminals, and whether the protocol layer and policy engine circuit has requested to transmit communication using one of the first set of CC terminals or the second set of CC terminals.

8. The circuit of claim 6, further comprising:
a third set of CC terminals comprising fifth and sixth CC terminals; and
a fourth multiplexer having first and second inputs, a select input, and an output, the first input of the fourth multiplexer coupled to the fifth CC terminal, and the second input of the fourth multiplexer coupled to the sixth CC terminal, wherein:
the communication policy engine comprises a second communication physical layer circuit having first and second inputs and an output,
the protocol layer and policy engine circuit has a third input and a third output,
the output of the fourth multiplexer coupled to the first input of the second communication physical layer circuit,
the output of the second communication physical layer circuit coupled to the third input of the protocol layer and policy engine circuit, and
the third output of the protocol layer and policy engine circuit coupled to the second input of the second communication physical layer circuit.

9. A system, comprising:
a first communication port comprising first and second CC terminals;
a second communication port comprising third and fourth CC terminals;
a first multiplexer having first and second inputs, a select input, and an output, the first input of the first multiplexer coupled to the first CC terminal, and the second input of the first multiplexer coupled to the second CC terminal;
a second multiplexer having first and second inputs, a select input, and an output, the first input of the second multiplexer coupled to the third CC terminal, and the second input of the second multiplexer coupled to the fourth CC terminal;
a logic circuit having first, second, and third inputs and an output, the first input of the logic circuit coupled to the output of the first multiplexer, and the second input of the logic circuit coupled to the output of the second multiplexer;
a third multiplexer having first and second inputs, a select input, and an output, the first input of the third multiplexer coupled to the output of the first multiplexer, the second input of the third multiplexer coupled to the output of the second multiplexer, and the select input of the third multiplexer coupled to the output of the logic circuit; and
a communication policy engine comprising:
a communication physical layer circuit having first and second inputs and an output, the first input of the communication physical layer circuit coupled to the output of the third multiplexer; and
a protocol layer and policy engine circuit having first and second inputs and first and second outputs, the first input of the protocol layer and policy engine circuit coupled to the output of the logic circuit, the second input of the protocol layer and policy engine circuit coupled to the output of the communication physical layer circuit, the first output of the protocol layer and policy engine circuit coupled to the second input of the communication physical layer circuit, and the second output of the protocol layer and policy engine circuit coupled to the third input of the logic circuit.

10. The system of claim 9, wherein the logic circuit is configured to:
provide a channel selection control signal to the protocol layer and policy engine circuit, the channel selection control signal configured to control the protocol layer and policy engine circuit to use one of the first communication port or the second communication port for communication by the communication policy engine; and
determine a value of the channel selection control signal based on a squelch status of the first communication port and the second communication port, a number of missed messages at the first communication port and the second communication port, and whether the protocol layer and policy engine circuit has requested to transmit communication using one of the first communication port or the second communication port.

11. The system of claim 9, wherein the logic circuit has a second output, the system further comprising:
a third communication port comprising fifth and sixth CC terminals;
a fourth multiplexer having first and second inputs, a select input, and an output, the first input of the fourth multiplexer coupled to the fifth CC terminal, and the second input of the fourth multiplexer coupled to the sixth CC terminal; and
a fifth multiplexer having first, second, and third inputs, a select input, and an output, the first input of the fifth multiplexer coupled to the output of the first multiplexer, the second input of the fifth multiplexer coupled to the output of the second multiplexer, the third input of the fifth multiplexer coupled to the output of the fourth multiplexer, and the select input of the fifth multiplexer coupled to the second output of the logic circuit.

12. The system of claim 11, wherein the protocol layer and policy engine circuit has third and fourth inputs and a third output, the third input of the protocol layer and policy engine circuit coupled to the second output of the logic circuit, the system further comprising:
a second communication physical layer circuit having first and second inputs and an output, the first input of the second communication physical layer circuit coupled to the output of the fifth multiplexer, the second input of the second communication physical layer circuit coupled to the third output of the protocol layer and policy engine circuit, and the output of the second communication physical layer circuit coupled to the fourth input of the protocol layer and policy engine circuit.

13. The system of claim 12, wherein the logic circuit comprises:
squelch detection logic circuits coupled to each communication port;
a priority port logic circuit coupled to each squelch detection logic circuit;
a channel control logic circuit coupled to the priority port logic circuit;
channel transition logic circuits coupled to the channel control logic circuit;
a channel select logic circuit coupled to the channel transition logic circuits; and
channel status logic circuits coupled to the channel select logic circuit, the squelch detection logic circuits, and the priority port logic circuit.

14. The system of claim 13, wherein the logic circuit is configured to execute instructions to implement the channel control logic circuit, the channel transition logic circuits, and the channel status logic circuits as state machines.

15. The system of claim 12, wherein the logic circuit is configured to:
provide a first channel selection control signal to the protocol layer and policy engine circuit, the first channel selection control signal configured to control the protocol layer and policy engine circuit to use one of the first communication port or the second communication port for communication by the communication policy engine;
provide a second channel selection control signal to the protocol layer and policy engine circuit, the second channel selection control signal configured to control the protocol layer and policy engine circuit to use one of the first communication port, the second communication port, or the third communication port for communication by the communication policy engine;
determine a value of the first channel selection control signal based on a squelch status of the first communication port and the second communication port, a number of missed messages at the first communication port and the second communication port, and whether the protocol layer and policy engine circuit has requested to transmit communication using one of the first communication port or the second communication port; and
determine a value of the second channel selection control signal based on a squelch status of the first communication port, the second communication port, and the third communication port, a number of missed messages at the first communication port, the second communication port, and the third communication port, and whether the protocol layer and policy engine circuit has requested to transmit communication using one of the first communication port, the second communication port, or the third communication port.

16. The system of claim 9, wherein the logic circuit controls operation of the protocol layer and policy engine circuit to cause the communication physical layer circuit to be shared between the first communication port and the second communication port.

17. A method, comprising:
determining, via a logic circuit, squelch statuses of each of multiple configuration channels;
determining, via the logic circuit, a number of missed messages for each of the configuration channels;
determining, via the logic circuit, a transmit status of a communication policy engine;
determining, via the logic circuit and based on the squelch status of the configuration channels, the number of missed messages for each of the configuration channels, and the transmit status of a communication policy engine, a configuration channel of the configuration channels to communicatively couple to the communication policy engine; and
communicatively couple the determined configuration channel of the configuration channels to a physical layer circuit.

18. The method of claim 17, wherein to determine each of the squelch statuses, the method comprises determining whether a value of a signal received via the configuration channels exceeds a threshold value.

19. The method of claim 17, wherein to determine the number of missed messages, the method comprises determining whether a number of edges in a signal received via the configuration channels within a programmed time period exceeds a threshold.

20. The method of claim 17, comprising controlling the communication policy engine, via the logic circuit, to cause the physical layer circuit of the communication policy engine to be shared among the configuration channels.
